(19) United States
(12) Patent Application Publication
(10) Pub. No.: US 2026/0131975 A1
(43) Pub. Date: May 14, 2026

(54) A TWIST-LOCK STORAGE SYSTEM AND ASSOCIATED METHOD

(71) Applicant: DP World UAE Region FZE, Dubai (AE)

(72) Inventors: Attila Bálint, Mórahalom (HU); Giancarlo Poli, Milan (IT); Samuel Corral Aviles, Milan (IT); Laszlo Kiss, Orbottyan (HU); Fahim Rashid Hussain, Dubai (AE); Balazs Daniel, Budapest (HU); Máté Bárány, Varsány (HU)

(21) Appl. No.: 19/118,759

(22) PCT Filed: Oct. 7, 2022
(86) PCT No.: PCT/IB2022/059602

§ 371 Date: Apr. 4, 2025

(51) Int. Cl. B65G 1/137; B65D 90/00; G06Q 10/0875

(52) U.S. Cl. CPC B65G 1/1371; B65D 90/0013; G06Q 10/0875; B65D 2590/0033; B65G 2203/0216

(57) ABSTRACT

According to an aspect of this disclosure, there is provided a classified lock storage system for container twist-locks. The classified lock storage system configured to store a plurality of classified twist-locks in an organised and traceable manner. The classified lock storage system comprises: a classified lock store having a capacity to store the plurality of classified twist-locks, wherein the classified lock store comprises a plurality of storage locations each of which configured to temporarily store one classified twist-lock from the plurality of classified twist-locks until the classified twist-lock is retrieved for use in a pinning operation: one or more storage input stations through which twist-locks can be put into the classified lock storage system: one or more storage output stations through which twist-locks can be removed from the classified lock storage system; and a classified lock transportation system usable to move twist-locks around the classified lock storage system.

### CROSS-REFERENCE TO RELATED APPLICATIONS

This application is related to co-pending application No. PCT/IB2022/059599, entitled “A TWIST-LOCK CLASSIFICATION SYSTEM AND METHOD”, and filed on the same date (7 Oct. 2022) as this application. That application is incorporated herein by reference, including that application's specification, and is not admitted to being prior art with respect to the matter disclosed in this application by that application's mention in the cross-reference section.

### TECHNICAL FIELD

Disclosed herein is a method of managing and storing container twist-locks and a container twist-lock storage system.

### BACKGROUND

Intermodal containers are used to transport cargo-in most cases non-bulk cargo- and are also known as shipping containers and/or ISO containers because they conform to international (ISO) specifications. The containers are usually re-useable and form the basis of an intermodal global freight system in which the containers are transportable via, and are transferrable between, a variety of transport modes without the need to open the containers and move the cargo stored therein. Provided in a variety of standard sizes, such as so-called “20-foot containers”, “40-foot containers” or “45-foot containers”, the intermodal containers comprise a rectangular cuboid container body and can be tightly packed together for storage or transport. For instance, containers can be stacked ten or more high into a vessel hull. At least one of the sides of the container is openable via a lockable door so that the interior of the container can be accessed. Rectangular 20-foot container, 40-foot containers and 45-foot containers respectively have lengthwise dimensions of 20 feet (6.096 meters), 40 feet (12.192 m) and 45 feet (13.716 meters). Standard container heights are 2.5 meters or 2.9 meters.

Various systems are employed to secure stacked containers for transport or storage. Lashings, removable stacking frames, twist-lock connectors, mid-locks, stacking cones, orienting pins, latching devices, and hooks are used in various combinations to secure the containers in position for transport. To assist with handling, lifting, and securing the containers containers in position for transport. To assist with handling, lifting, and securing the containers to one another, the intermodal containers comprise a standardized mounting means in the form of cuboid corner blocks (also called “mounting blocks” or “corner castings”). The corner blocks can accommodate fixings such as twist-lock connectors and stacking cones that can be used to connect the containers to one another.

In most instances, the containers include eight corner blocks, each of which is rigidly fixed at a respective corner of the cuboid container. The corner blocks are usually located in a recess such that the free, external faces of the corner blocks are substantially flush or slightly proud of the corresponding sides of the container associated therewith. Each corner block typically comprises a hollow fabricated or cast box-like structure, usually made from steel, which defines an internal space. The external sides of the corner block define openings in the form of slots of a standard size and shape which lead into the internal space. The slots are typically ovaloid in shape and are configured to co-operatively receive corner block mounting formations, such as, for example, orientating pins, latching devices, hooks, twist-lock connectors, stacking cones or other hardware.

Certain mounting formations, such as twist-lock connectors, can be used to connect containers to one another, for instance containers that are arranged in a stack. Twist-locks have at least one anchor that is usable to releasably lock the twist-lock to a corner block. The anchor projects from the supporting body and has a shape that is complementary to the shape of the ovaloid slot of a corresponding corner block. In use, the anchor is inserted into the internal space of an associated corner block via the correspondingly shaped slot of the corner block and engages an inner surface of the corner block. Once locked in place, the twist-lock can be used to assist with connecting the container to another container (or to another structure, such as the deck of a vessel). Operationally, the fitting and removal of twist-locks to and from containers may be described as “pinning” or “pinning operations”.

In some twist-locks, the at least one anchor is a cam that is movable relative to a supporting body of the twist-lock. Once located within the internal space, the cam is moved, for instance by rotation, such that the cam engages the inner surface of the corner block thereby releasably locking the twist-lock to the corner block. Twist-locks that are used to connect containers to one another may have a second movable cam that projects from the supporting body in a direction opposite to that of the cam. To secure a pair of containers together, for instance as part of a stack, corresponding sides from each container are placed in alignment such that corresponding corner blocks located on the corresponding sides are aligned with one another The opposing cams of a twist-lock are each inserted into respective interior spaces of neighbouring corner blocks and engaged with the corner blocks so as to lock the containers to one another.

Twist-locks may be described as fully automatic or semi-automatic. For instance, a fully automatic twist-lock comprises one or more anchors that lock automatically to a corresponding corner block on insertion. A fully automatic twist-lock may have no moving parts—for instance, the anchors of a fully automatic twist-lock may be engaged using the relative motion between containers as they are connected to one another. Alternatively, a fully automatic twist-lock may have moving parts that are activated on insertion into a corner block. Semi-automatic twist-locks may comprise moving parts, such as the cams described above, that are automatically activated when one or more anchors are inserted into corresponding corner blocks to lock the twist-lock thereto but that require manual intervention, such as via an operating rod or pull cable, to release the anchor from the corner block. Twist-locks may also be entirely manually operated, for example via an operating rod or pull cable that, when actuated, locks or releases one or more anchors to or from a corresponding corner block.

Operationally, intermodal containers travel through handling facilities such as container terminals located at ports or freight yards. At a container handling port, for example, containers are offloaded from ships and loading onto flat-bed trucks or trains passing through the container terminal, or onto another vessel for onward travel. Since the containers discharged from a vessel or other vehicle type are not usually all destined for the same cargo unloading point, the twist-locks that previously held a particular container securely in a stack of containers can require removal before the container is moved to another location for storage or further transport. Conversely, twist-locks can require fitting to a container before that container is stacked within a vessel.

### SUMMARY

This summary is provided to introduce, in a simplified form, a selection of concepts that are further described below in the detailed description. This summary is not intended to identify key or essential features of the claimed subject-matter, nor is it intended to be used as an aid in determining the scope of the claimed subject-matter.

According to an aspect of this disclosure, there is provided a classified lock storage system for container twist-locks. The classified lock storage system configured to store a plurality of classified twist-locks in an organised and traceable manner. The classified lock storage system comprises: a classified lock store having a capacity to store the plurality of classified twist-locks, wherein the classified lock store comprises a plurality of storage locations each of which configured to temporarily store one classified twist-lock from the plurality of classified twist-locks until the classified twist-lock is retrieved for use in a pinning operation; one or more storage input stations through which twist-locks can be put into the classified lock storage system; one or more storage output stations through which twist-locks can be removed from the classified lock storage system; and a classified lock transportation system usable to move twist-locks around the classified lock storage system.

According to another aspect of this disclosure, there is provided a method for managing a twist-lock in a classified lock storage system. The method comprises: retrieving, from an input station, a universal lock carrier loaded with a classified twist-lock; transporting the universal lock carrier to a classified lock store; identifying a free storage location in the classified lock store and assigning the storage location to the universal lock carrier; and placing the universal lock carrier in the storage location.

According to another aspect of this disclosure, there is provided a method for managing a twist-lock in a classified lock storage system. The method comprises: retrieving, using data representing an association between a storage location and a universal lock carrier placed therein and data representing an association between the universal lock carrier and a classification of a twist-lock, the universal lock carrier from the storage location; transporting the universal lock carrier to an output station; and depositing the twist-lock loaded on the universal lock carrier at the output station.

According to another aspect of this disclosure, there is provided a non-transitory, machine-readable storage medium comprising machine readable instructions executable by a processor, the storage medium comprising instructions to: retrieve, from an input station, a universal lock carrier loaded with a classified twist-lock; transport the universal lock carrier to a classified lock store; identify a free storage location in the classified lock store and assign the storage location to the universal lock carrier; and place the universal lock carrier in the storage location.

According to another aspect of this disclosure, there is provided a non-transitory, machine-readable storage medium comprising machine readable instructions executable by a processor, the storage medium comprising instructions to: retrieve, using data representing an association between a storage location and a universal lock carrier placed therein and data representing an association between the universal lock carrier and a classification of a twist-lock, the universal lock carrier from the storage location; transport the universal lock carrier to an output station; and deposit the twist-lock loaded on the universal lock carrier at the output station.

### BRIEF DESCRIPTION OF THE DRAWINGS

Further features of the disclosure are described hereinafter, by way of non-limiting examples of the invention, with reference to and as illustrated in the accompanying drawings, in which:

FIG. 1 schematically illustrates a workflow for twist-lock connectors in a container lock management system, as described herein;

FIG. 2 is a schematic diagram illustrating an example of a container pinning system, as described herein;

FIG. 3 is a flow diagram of an example method for classifying twist-locks;

FIG. 4 is a flow diagram of an example method of fixing a twist-lock to a corner block of a container;

FIG. 5 is a schematic diagram of a pinning station controller;

FIG. 6 is a perspective view of a machine vision system for use in a container pinning system, as described herein;

FIG. 7 shows an example of a semi-automatic twist-lock that may be used in the container lock management system;

FIG. 8 shows an example of a mid-lock that may be used in the container lock management system;

FIG. 9 schematically illustrates a lock classification system, as described herein;

FIG. 10 is a flow diagram of an example method for classifying twist-locks;

FIG. 11 is a schematic diagram of a classification controller;

FIG. 12 is a schematic diagram of another example of a lock classification system, as described herein;

FIG. 13a is a perspective view of another example of a lock classification system, as described herein;

FIG. 13b shows a cross-sectional view of a portion of the feeder of the lock classification system of FIG. 13a;

FIG. 14 is a perspective view of a machine vision system for use in a lock classification system, as described herein;

FIG. 15 is a schematic diagram illustrating an example of a classified lock storage system, as described herein;

FIG. 16a is a flow diagram of an example method of storing a classified twist-lock in a classified lock storage system;

FIG. 16b is a flow diagram of an example method of retrieving a classified twist-lock from a classified lock storage system;

FIG. 17 is a perspective view of another example of a classified lock storage system, as described herein;

FIG. 18 shows elevation and plan views of the classified lock storage system of FIG. 17;

FIG. 19 is a perspective view of lock transportation system of the classified lock storage system of FIG. 17;

FIG. 20 is a schematic diagram of a lock storage controller;

FIG. 21 is a schematically illustrates a carrier stool and universal lock carriers, as described herein;

FIGS. 22 and 23 are perspective views of an example of a universal lock carrier;

FIGS. 24, 25, and 26 are perspective views of carrier stools examples;

FIG. 27 shows a conceptual perspective view of an embodiment of a container twist-lock pinning/unpinning assembly in accordance with the invention;

FIG. 28 shows a perspective top view of another embodiment of a container twist-lock pinning/unpinning assembly in accordance with the invention;

FIG. 29 shows another perspective front view of the container twist-lock pinning/unpinning assembly of FIG. 28;

FIG. 30 shows a top view of the container twist-lock pinning/unpinning assembly of FIG. 28;

FIG. 31 shows a top view of the container twist-lock pinning/unpinning assembly of FIG. 28 with parts of the assembly not shown for enhanced clarity;

FIG. 32 shows an enlarged fragmentary perspective view of a part of the assembly indicated with reference “V” in FIG. 29;

FIG. 33 is a conceptual top view showing jaw members of the container twist-lock pinning/unpinning assembly of FIG. 28 in various positions;

FIG. 34a is a conceptual side view of a twist-lock, showing a central axis of the twist lock aligned with an axis of rotation of the twist-lock;

FIG. 34b is a conceptual side view of a twist-lock, showing a central axis of the twist lock offset with respect to an axis of rotation of the twist-lock;

FIG. 35a shows a conceptual top view of a twist-lock, showing a central axis of the twist lock aligned with an axis of rotation of the twist-lock;

FIG. 35b shows a conceptual top view of a twist-lock, showing a central axis of the twist lock offset with respect to an axis of rotation of the twist-lock;

FIGS. 36a to 36d show a top view of the twist-lock pinning/unpinning assembly of FIG. 28, illustrated with adjustable fingers of jaw members thereof gripping a twist-lock in various configurations;

FIGS. 37a to 37c show the twist-lock pinning/unpinning assembly of FIG. 28, illustrated in various movable configurations thereof; and

FIG. 38 shows a top view of a lower portion of the twist-lock pinning/unpinning assembly of FIG. 28, with upper parts not shown for additional clarity and ease of understanding.

### DETAILED DESCRIPTION

In this description, the term “container” shall be interpreted to mean a container of the type as hereinabove described and the terms “slots”, “corner blocks” and “corner block mounting formation” shall be interpreted to mean slots, corner blocks and corner block mounting formations of the types as hereinabove described.

According to the present disclosure, the various sides of the container shall be named with reference to the orientation of a resting container, in other words, the bottom shall refer to the side upon which the container rests, the top shall refer to the opposite operatively upper end of the container and the vertical sides shall refer to the sides of the container extending between the top and the bottom of the container.

The Applicant conceives that the systems described herein are operable to manage all corner block mounting formations of the types described herein. Accordingly, in this description, operations, processes, methods, and apparatuses described with reference to the management of “locks”, “twist-lock(s)”, or “twist-lock connector(s)” are considered by the Applicant to be described with reference to: orientating pins, latching devices, hooks, twist-lock connectors, mid-locks, stacking cones, and/or other hardware that is receivable within the internal space of a corner block.

In this description, the term “container pinning”, “pinning”, or “pinning operations” shall be interpreted to mean the process of removing or attaching corner block mounting formations, such as twist-locks, to one or more corner blocks of an intermodal container.

In this description, the term “machine vision” or “machine vision system” shall be interpreted to mean a system configured to extract information from one or more captured images (including digital images) on an automated basis. The system may include image processing modules configured to extract the information and/or make determinations about the content of the captured images. The image processing modules may be configured to output further images based on the captured images. The system may include modules configured to make decisions based on the content of the captured images and/or output those decisions to other systems via a suitable interface.

As can be seen from the discussion above, the logistics involved in managing intermodal containers at handling facilities such as ports or freight yards are complex. In facilities where many containers are being handled, a correspondingly large number of twist-locks and the like require removal and fitting to containers. Handling many twist-locks presents container facilities with logistical challenges. For instance, the fitting and removing of twist-locks and stacking cones is a time-consuming and laborious manual process. Furthermore, several different types and models of twist-locks and stacking cones may be in use at one time. One vessel may use several different types of twist-lock and those types may be different from another vessel. For instance, different types of twist-lock may be utilised to secure different containers on a vessel and the selection of twist-locks for a particular container may be dependent on the location of that container on the vessel.

Having a wide variety of twist-locks in use at any one time in a container facility can present a logistical storage challenge. Storage issues are further compounded because the twist-locks and stacking cones are awkward shapes that enmesh and jam easily. Twist-locks of differing types being stored in a single repository can make it difficult and time-consuming to source the appropriate twist-lock for a particular operation. In certain container-handling operations, for instance in the loading and unloading of container vessels, some twist-locks may be offloaded from a particular vessel's twist-lock store for use in pinning operations. Any of the vessel's own twist-locks that are unused in pinning operations are usually returned to the vessel before departure.

Since the performance of a container handling facility is measured according to the number of containers which are handled and moved during operating hours of the terminal, reducing the amount of time and resource involved in managing the use of twist-locks in the facility is desirable.

Providing an automated container pinning/unpinning station and system which is automated and specifically does not use human labour and assistance in the work area is considered to be particularly beneficial. Not using human labour and assistance ameliorates the risk of death and or injury of persons working as stevedores, dock workers, etc, which are statistically high-risk occupations. In this regard, conventional container pinning/unpinning operations require human labour and/or assistance in the fitment and unpinning of twist locks from corner blocks of interconnected containers and, as such, the human assistants/workers are exposed to danger of accident and death.

The Applicant considers that the container lock management systems, classified lock storage systems, and methods described herein will address these issues and, in particular, improve the sorting of different twist-lock types, reduce handling effort, improve storage speeds, improve retrieval speeds, save time and cost, and reduce human involvement in labouring in the container work area.

A classified lock storage system for container twist-locks comprises: a classified lock store having a capacity to store the plurality of classified twist-locks; one or more storage input stations through which twist-locks can be put into the classified lock storage system; one or more storage output stations through which twist-locks can be removed from the classified lock storage system; and a classified lock transportation system usable to move twist-locks around the classified lock storage system. The classified lock storage system is configured to store a plurality of classified twist-locks in an organised and traceable manner. The classified lock store comprises a plurality of storage locations each of which configured to temporarily store one classified twist-lock from the plurality of classified twist-locks until the classified twist-lock is retrieved for use in a pinning operation.

The classified lock storage system may be configured to maintain an inventory of stored classified twist-locks according to the classification of twist-lock stored in each storage location. The classified lock storage system may be configured to maintain a record of the type and/or model of twist-lock stored in a particular storage location.

The classified lock transportation system may be configured to, in use, receive classified twist-locks from the one or more storage input stations and deliver the classified twist-locks to the classified lock store for storage in one of the storage locations and/or may be configured to, in use, retrieve classified twist-locks from the classified lock store and to deposit the classified twist-locks at the one or more storage output stations.

Classified twist-locks may be receivable at one of the one or more storage input stations from a corresponding lock classification system and/or at one of the one or more storage input stations from a container pinning system. Retrieved classified twist-locks may be depositable at one or more storage output stations for use in a corresponding container pinning system.

The classified lock storage system may comprise a lock storage controller to control the operation of the classified lock storage system. The lock storage controller may be communicatively coupled to one or more of: the classified lock store, the classified lock transportation system, the one or more storage input stations, and/or the one or more storage output stations. The lock storage controller may comprise: a transportation control module to control the classified lock transportation system; and an inventory management module to maintain an inventory of classified twist-locks that are managed and stored by the classified lock storage system. The lock storage controller may comprise a storage module, for instance to store machine readable instructions that are executable by processing circuitry and/or store data usable by the controller such as data relating to the inventory of classified twist-locks.

The classified lock storage system may be configured to manage and store each classified twist-lock using a universal lock carrier on which the classified twist-lock is loaded. Each storage location of the classified lock store may comprise a berth that is configured to removably receive each universal lock carrier. The classified lock storage system may comprise an idle carrier store configured to store universal lock carriers when not in use.

The classified lock transportation system may be configured to transport universal lock carriers, and wherein the classified lock transportation system compromises a carrier interface that is complementary to, and engages with, a storage system interface common to each universal lock carrier.

The classified lock transportation system comprises one or more guided vehicles that are each configured to removably receive and hold each universal lock carrier. Each input station may comprise one or more carrier stools. Each output station may comprise one or more carrier stools. Each carrier stool may be configured to releasably support each universal lock carrier. The classified lock storage system may comprise one or more carrier emptying stations where classified twist-locks are unloadable from universal lock carriers.

The lock storage controller may keep track of the movements of a universal lock carrier within the classified lock storage system, for instance through a list of movement instructions for the universal lock carrier that have been issued by the lock storage controller as the universal lock carrier is managed in the classified lock storage system. By keeping track of the movements of the universal lock carrier, the lock storage controller may monitor the location of the universal lock carrier, whether a twist-lock is loaded on the universal lock carrier, and the classification of such a twist-lock. The lock storage controller may also comprise a carrier monitoring module configured to monitor the location of universal lock carriers within the classified lock storage system. The lock storage controller may also comprise a carrier identification module configured to identify universal lock carriers within the classified lock storage system.

The one or more storage input stations and/or the one or more storage output stations may each comprise a radio-frequency identification (RFID) reader configured to interrogate a RFID tag of each universal lock carrier.

The classified lock storage system may have a substantially linear arrangement. For example, two classified lock store depositories for twist-lock storage may be located at substantially opposing ends of the classified lock transportation system. Classified twist-locks may be transported along a line between the two depositories and storage input stations, storage input/output stations, and storage output stations that are also arranged along the linearly arranged classified lock transportation system. The classified lock storage system may interface with one or more container pinning systems. The classified lock storage system may interface with one or more lock classification systems.

The classified lock transportation system may comprise a guide and a guided vehicle that is movable along the length of the guide. The guided vehicle may comprise a lift module configured to, in use, lift a carrier handler up and down so that universal lock carriers can be placed into the storage berths of the classified lock store and be placed on the carrier stools by the carrier handler. The lift module may comprise a mast projecting upwardly from, and is mounted to, a body of the guided vehicle, and wherein the mast is rotatable relative to the body. The carrier handler may be configured to, in use, move each universal lock carrier laterally of the guide to perform placing operations. The carrier handler may comprise a carrier interface that is configured to support a universal lock carrier in which the carrier interface is configured to be complementary to, and engage with, a storage system interface of the transported universal lock carrier.

A container lock management system may comprise: one or more container pinning systems as described herein; and one or more of any of the classified lock storage systems as described herein. The container lock management system may comprise one or more of any of the lock classification systems as described herein. The container lock management system may comprise one or more universal lock carriers as described herein.

A method for managing a twist-lock in a classified lock storage system comprises: retrieving, from an input station, a universal lock carrier loaded with a classified twist-lock; transporting the universal lock carrier to a classified lock store; identifying a free storage location in the classified lock store and assigning the storage location to the universal lock carrier; and placing the universal lock carrier in the storage location.

Retrieving the universal lock carrier loaded with the classified twist-lock may comprise retrieving the universal lock carrier from a container pinning system or a lock classification system.

The method may comprise generating data representing an association between the universal lock carrier and a classification of the twist-lock, wherein the data is generated based on, or from, data representing an association between the classification and the twist-lock loaded on the universal lock carrier. The data may be generated based on a unique identifier linked with the universal lock carrier. The method may comprise recording the data representing an association between the universal lock carrier and a classification of the twist-lock in an inventory database.

The method may comprise generating data representing an association between the storage location and the universal lock carrier placed therein. The method may comprise recording the data representing the association between the storage location and the universal lock carrier in the inventory database.

A method for managing a twist-lock in a classified lock storage system comprises: retrieving, using data representing an association between a storage location and a universal lock carrier placed therein and data representing an association between the universal lock carrier and a classification of a twist-lock, the universal lock carrier from the storage location; transporting the universal lock carrier to an output station; and depositing the twist-lock loaded on the universal lock carrier at the output station.

Retrieving the universal lock carrier may be in response to a request for one or more twist-locks having the classification of the twist-lock. Depositing the twist-lock at the output station may comprises delivering the twist-lock to a container pinning system for use in pinning operations.

The method may comprise updating, deleting, and/or archiving, in/from an inventory database, the data representing the association between the universal lock carrier and the classification of the twist-lock and/or the data representing the association between the storage location and the universal lock carrier.

A non-transitory, machine-readable storage medium comprising machine readable instructions executable by a processor, comprises instructions to: retrieve, from an input station, a universal lock carrier loaded with a classified twist-lock; transport the universal lock carrier to a classified lock store; identify a free storage location in the classified lock store and assign the storage location to the universal lock carrier; and place the universal lock carrier in the storage location.

A non-transitory, machine-readable storage medium comprising machine readable instructions executable by a processor, comprises instructions to: retrieve, using data representing an association between a storage location and a universal lock carrier placed therein and data representing an association between the universal lock carrier and a classification of a twist-lock, the universal lock carrier from the storage location; transport the universal lock carrier to an output station; and deposit the twist-lock loaded on the universal lock carrier at the output station.

Further examples are described below with reference to the drawings. A table of reference signs used in the drawings is set out below.

| Item | Ref. | Item | Ref. |
|---|---|---|---|
| Intermodal Container | 10 | Sleeve | 4282 |
| Corner Block | 12 | Carrier Interface | 4284 |
| Container Support | 20 | Orientation Protrusions | 4286 |
| Independent Lock Store | 40 | Extendible Arm | 4288 |
| Lock Bin(s) | 42 | Arm Motor | 4289 |
| Twist-Lock | 50 | Storage Input Station | 430 |
| Supporting Body | 51 | Storage Input/Output Station | 430/440 |
| Anchor | 52 | Storage Output Station | 440 |
| Cam | 54 | Lock Storage Controller | 450 |
| Lock Actuator | 56 | Processing Circuitry | 451 |
| Slidable Cam | 57 | Transportation Control Module | 452 |
| Container Lock Management System | 100 | Inventory Management Module | 453 |
| Container Pinning System | 200 | Carrier Monitoring Module | 454 |
| Container Positioning System | 202 | Carrier Identification Module | 455 |
| Container Pinning Station | 204 | Storage Module | 458 |
| Lock Manipulator | 210 | Communications Interface | 459 |
| Mechanical Arm | 212 | Idle Carrier Store | 460 |
| Lock Identifier | 220 | Carrier Emptying Station | 470 |
| Machine Vision System | 222 | Unloaded Lock Bin | 472 |
| Image Sensor | 224 | Unclassified Lock Storage | 500 |
| Frame | 226 | Carrier Stool | 600 |
| Adjustable Bracket | 227 | Pedestal | 610 |
| Shield | 228 | Seat | 620 |
| Pinning Station Controller | 230 | Frame | 621 |
| Processing Circuitry | 231 | Positioning Elements | 622 |
| Identifier Module | 232 | Alignment Pin | 624 |
| Manipulation Solution Module | 233 | Stop | 626 |
| Lock Manipulator Module | 234 | Calibration Element | 628 |
| Stool Management Module | 235 | Alignment Pin Plate | 629 |
| Storage Module | 238 | Sensors | 630 |
| Communications Interface | 239 | Carrier Detector | 632 |
| Retrieved Lock Receptacle | 240 | Lock Detector | 634 |
| Lock Drop Bin | 242 | Communication Cable | 635 |
| Lock Classification System | 300 | ID Reader | 640 |
| Feeder | 310 | Elevator | 650 |
| Hopper | 312 | Tilt Mechanism | 660 |
| Feed Conveyor | 314 | Actuator | 662 |
| Feed Conveyor Guide | 315 | Latch | 664 |
| Separator | 320 | Universal Lock Carrier | 700 |
| Conveyors | 322 | Cradle | 710 |
| First Conveyor | 322a | Guides | 712 |
| Second Conveyor | 322b | Location Elements | 714 |
| Conveyor Motor | 323 | Contact Elements | 716 |
| Chassis | 324 | Uprights | 718 |
| Lock Positioner | 330 | Storage System Interface | 720 |
| Diverter | 332 | Base Plate | 722 |
| Lock Identifier | 340 | Orientation Slots | 724 |
| Machine Vision System | 342 | Cutout | 726 |
| Image Sensor | 343 | Complementary Positioning Elements | 730 |
| Frame | 346 | Alignment Pin Receptacle | 732 |
| Adjustable Bracket | 347 | Unique Identifier Support | 740 |
| Identification Conveyor | 344 | Pinning Gripper | 800 |
| Manipulation Solution System | 350 | Twist-lock Body Gripping Attachment | 808 |
| Lock Manipulator | 360 | Opposable Jaw Members | 810 |
| Mechanical Arm | 362 | Jaw Member | 810a |
| Gripper | 364 | Jaw Member | 810b |
| Lock Discharge | 370 | Fingers | 820 |
| Return Conveyor | 372 | Movable Finger | 820a1 |
| Discharge Bin | 374 | Movable Finger | 820a2 |
| Classification Controller | 380 | Movable Finger | 820b1 |
| Processing Circuitry | 381 | Movable Finger | 820b2 |
| Feeder Module | 382 | Cam Actuating Mechanism | 812 |
| Separator Module | 383 | Cam Gripping Attachment | 822 |
| Identifier Module | 384 | Upstanding Pin Members | 824 |
| Manipulation Solution Module | 385 | Rotary Actuator | 814 |
| Lock Manipulator Module | 386 | Pneumatic Cylinder | 836 |
| Stool Management Module | 387 | Pneumatic Cylinder | 838 |
| Storage Module | 388 | Base Plate | 840 |
| Communications Interface | 389 | Locking Pin Assembly | 842 |
| Classified Lock Storage System | 400 | Latching Cylinder | 844 |
| Classified Lock Store | 410 | Latching Slot | 846a |
| Plurality of Storage Berths | 412 | Latching Slot | 846b |
| Angle Bars | 414 | Latching Slot | 846c |
| Supporting Frame | 415 | Jaw Member Displacing Cylinder | 850 |
| Classified Lock Transportation System | 420 | Pneumatic Cylinder Mechanism | 850a |
| Guide | 422 | Pneumatic Cylinder Mechanism | 850b |
| Rack | 423 | Finger Displacing Mechanism | 860 |
| Guided Vehicle | 424 | Pneumatic Cylinder | 862a1 |
| Vehicle Motors | 425 | Pneumatic Cylinder | 862a2 |
| Lift Module | 426 | Pneumatic Cylinder | 862b1 |
| Mast | 4262 | Pneumatic Cylinder | 862b2 |
| Chain Drive | 4264 | Twist-Lock | 950 |
| Carrier Handler | 428 | Twist-Lock | 1050 |

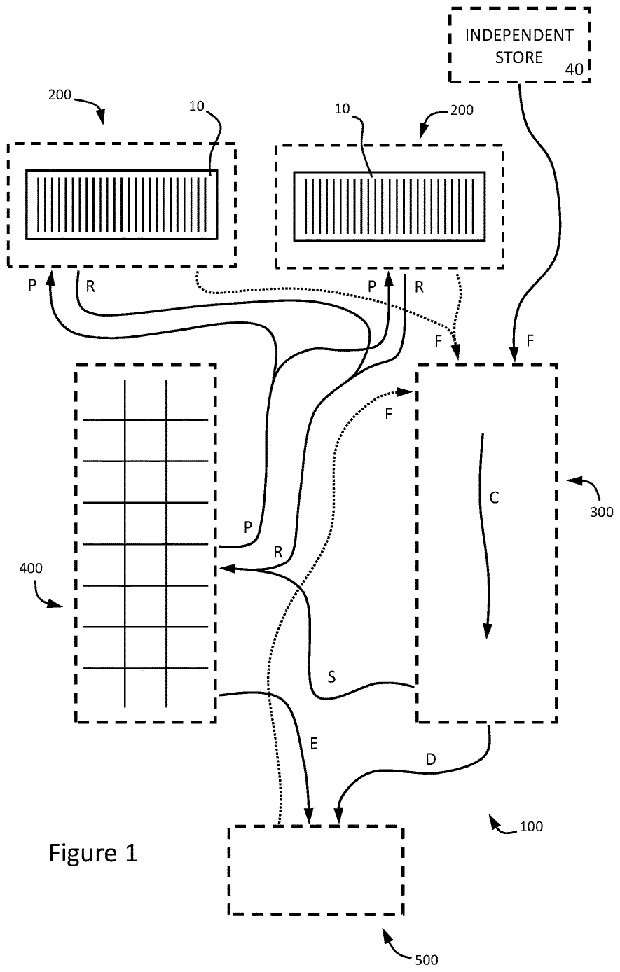

FIG. 1 illustrates the movement workflow for twist-lock connectors around a container lock management system 100 as described herein. The container lock management system 100 in the example of FIG. 1 comprises: at least one container pinning system 200, at least one lock classification system 300, and at least one classified lock storage system 400. The at least one container pinning system 200, the at least one lock classification system 300 and the at least one classified lock storage system 400 may be provided separately of each other or together in the container lock management system 100 in any suitable combination. For instance, the container lock management system 100 may comprise the at least one classified lock storage system 400 alone, or with the at least one container pinning system 200 and without the at least one lock classification system 300 or vice versa. In certain examples, container lock management system 100 may comprise an unclassified lock storage 500.

Each container pinning system 200 is configured for pinning intermodal containers with twist-locks. In other words, each container coning system 200 is configured to permit the fixing or the removal of twist-locks from one or more corner blocks of an intermodal container 10. The container lock management system 100 may comprise any suitable number of container pinning systems 200.

In use, twist-locks are moved, or travel, around the container lock management system 100 in the manner indicated by the arrows in FIG. 1. During pinning operations, twist-locks are retrieved from an intermodal container, for example, a container 10 that has been discharged from a vessel. The retrieved twist-locks are classified in the container pinning system 200. Selected classified twist-locks are transported R to be stored in the classified lock storage system 400 for later use in pinning operations.

In certain examples, twist-locks may be delivered into the container lock management system 100 from an alternative independent storage facility 40. For instance, where the container lock management system 100 is implemented in a container terminal port, a bin containing twist-locks belonging to, or associated with, a particular vessel may be unloaded from the vessel. Twist-locks may be fed F directly to the lock classification system 300 from the alternative independent storage facility 40. For instance, the bin containing twist-locks belonging to the particular vessel may be unloaded from the vessel and the twist-locks contained therein fed F directly into the lock classification system 300. It will be understood that the independent storage facility 40 may comprise one or more repositories that can store twist-locks and that twist-locks can be delivered to the lock classification system 300 from those repositories. It will also be understood that twist-locks retrieved from an intermodal container 10 and twist-locks delivered from the independent storage facility 40 may have originated from the same vessel. The twist-locks are classified C using the lock classification system 300. Selected classified twist-locks are transported S to be stored in the classified lock storage system 400.

The classified lock storage system 400 maintains a record all the stored twist-locks according to their classification, which allows for their retrieval and then use on an intermodal container according to the classification. In use, if a determination is made, for instance by a controller as described herein, that a certain classification of twist-lock is required for use in a pinning operation, for instance at one of the container pinning systems 200, one or more twist-locks of the required classification can be retrieved by the classified lock storage system 400 and be delivered P to one of the container pinning systems 200 for pinning to a corner block of a container 10.

In certain examples, a determination may be made, using the lock classification system 300, that a twist-lock passing through the container classification system 300 is not a classification of twist-lock that is required for use in a particular container pinning operation. For instance, only certain twist-lock classifications may be required to be stored for later use in a pinning operation. Relatedly, a determination may be made, using the lock classification system 300, that a twist-lock cannot be classified at all, for instance because the twist-lock is damaged or missing a component thereby being unclassifiable. Furthermore, the lock classification system 300 may need to handle contaminants and foreign matter that are not twist-locks at all. In these circumstances, the lock classification system 300 may be configured to discharge D the unselected twist-locks that do not meet the required classification or that cannot be classified to the unclassified lock storage 500.

Similarly, in certain examples, a determination may be made, in the container pinning system 200, that a twist-lock retrieved from the container 10 is not a classification of twist-lock that is required for use in a particular container pinning operation or that cannot be classified. In these circumstances, the container pinning system 200 may be configured to discard such unselected twist-locks. For instance, although not illustrated in FIG. 1 purely for the sake of illustrative clarity, the discarded twist-locks may be discarded to the unclassified lock storage 500.

Similarly, in certain examples, a determination may be made, for instance by a controller as described herein, that certain twist-locks are no longer required to be stored within the classified lock storage system 400. In such circumstances, those twist-locks may be emptied E into the unclassified lock storage 500 from the classified lock storage system 400.

The unclassified lock storage 500 may comprise any suitable number of repositories. For instance, the twist-locks discharged D from the lock classification system 300 and the twist-locks emptied E from the classified lock storage system 400 may be placed into the same repository or different repositories. In some examples, there may be several repositories distantly located from one another depending on the requirements of the particular container lock management system 100.

In some examples, twist-locks from the unclassified lock storage 500 may be returned and fed F into the lock classification system 300. For instance, a determination may be made that a different classification of twist-lock is required for use in a container pinning operation and therefore unclassified locks from the unclassified lock storage 500 may be returned to the lock classification system 300 for classification.

Furthermore, as noted above, twist-locks that are removed from an intermodal container 10 may not be classifiable in the container pinning system 200. For example, the type of twist-lock removed from a container 10 may not be determined. Such twist-locks may also be fed F into the lock classification system 300 from the container pinning system 200 as shown in FIG. 1 where a further attempt to classify those twist-locks may be made. Alternatively, as noted above, such twist-locks may be directly delivered to the unclassified lock storage 500.

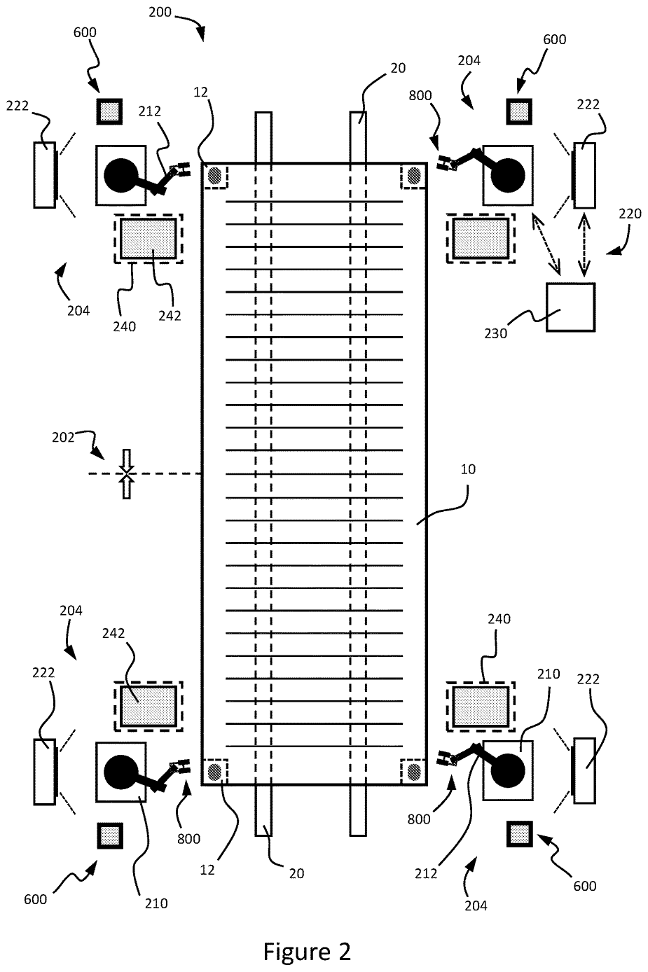

Turning now to FIG. 2, which shows one example of a container pinning system 200. The container pinning system 200 is configured to accommodate intermodal containers 10 for pinning operations. As schematically illustrated in FIG. 2, the container pinning system 200 may comprise a container positioning system 202 configured to ensure that the intermodal containers 10 are be positioned accurately and consistently in the same predetermined location so that accurate pinning operations may be conducted using the container pinning system 200. The intermodal containers 10 may be delivered to the container pinning system 200 on a container support 20. For instance, the container support 20 may be comprised in a container mover, such as a flat-bed truck, a grappler lift, or reach stacker, for example. In other examples, the container pinning system 200 may comprise a container support on to which the intermodal container 10 can be placed for a pinning operation—for instance, a container mover such as a gantry crane may be used to position the container 10 on the container support. The container positioning system 202 may be used to ensure that the container mover stops in the correct position or that the container is placed in the correct position for pinning operations. The container positioning system 202 may be communicatively connected to one or more controllers as described herein so that positioning information can be provided to a container mover.

The container pinning system 200 comprises at least one pinning station 204. The container pinning system 200 may comprise a plurality of pinning stations 204. The pinning station(s) 204 is/are configured to conduct pinning operations. Any suitable number of pinning stations 204 may be provided. In the example shown in FIG. 2, a container 10 has been delivered to the container pinning system 200 and is in position for container pinning operations to be conducted. Four pinning stations 204 are provided, each of which is located in the vicinity of a corner of the container 10 when the container 10 is located correctly for container pinning operations.

Each container pinning station 204 is configured to conduct pinning operations on a corresponding corner block of the container 10. In other words, each container pinning station 204 is operable to insert a twist-lock into position in a corner block of the container 10 and/or remove a twist-lock from a corner block of the container 10.

Each container pinning station 204, comprises a lock manipulator 210. The lock manipulator 210 is configured to, in use, move and manipulate a twist-lock so that the twist-lock can be fixed to, or removed from, a corner block 12 of a container 10. The lock manipulator 210 may comprise an autonomous machine configured to manipulate and move a twist-lock in three-dimensional space. For instance, the lock manipulator 210 may comprise a movable mechanical arm 212 having joints that permit rotational and/or translational motion to be imparted to a twist-lock. The lock manipulator 210 may comprise a pinning gripper 800, as described further below, which is configured to pick up and release the twist-lock, to hold the twist-lock during rotation and/or translation of the twist-lock in the three-dimensional space around the container pinning station 204, and to operate the twist-lock to lock/unlock the twist-lock from a corner block. As described further below, in some examples, the pinning gripper 800 is configured to, when required, actuate a cam of the twist-lock so that the twist-lock can be fixed to, or removed from, the corresponding corner block. The pinning gripper 800 is configured to be able to grip and manipulate one or more twist-lock classifications. The pinning gripper 800 may be mounted at a distal end of the mechanical arm 212. At the opposing, proximal end, the mechanical arm 212 may be mounted to a support that may deliver any power supplies and permit connection with one or more controllers that are used to control the mechanical arm 212 and/or pinning gripper 800. Each pinning station 204 may comprise a manipulation solution system that calculates sequences of motions of the lock manipulator 210 that cause the lock manipulator 210 to move from one position to another, for instance to move a twist-lock from a first position to a second position in three-dimensional space. The manipulation solution system may output such planned sequences of motions of the lock manipulator 210 as a lock manipulation solution. For example, the mechanical arm 212 and/or pinning gripper 800 may be controlled according to one or more sets of executable instructions, for instance stored on a storage medium that is associated with the one or more controllers.

Each container pinning station 204 comprises a lock identifier 220 and is configured to, using the lock identifier 220, classify twist-locks according to type and/or model of twist-lock. In one example, the lock identifier 220 may be configured to identify twist-locks in situ in the corner block 12—i.e., prior to removal of the twist-lock from the corner block 12. Identifying the twist-lock when located in the corner block 12 may allow the twist-lock to be quickly removed from the corner block 12 without requiring further identity analysis being performed once the twist-lock is removed. The lock identifier may be configured to determine the twist-lock's orientation in three-dimensional space, for instance relative to the lock manipulator 210 or other part of the container pinning station 204.

In other examples, the lock identifier 220 may be configured to identify twist-locks once removed from the corner block 12 by the lock manipulator 210. For instance, a twist-lock may be identified whilst being held by the lock manipulator 210 after removal.

Each container pinning station 204 is also configured to determine, based on the classification of a twist-lock, whether a twist-lock that is to be removed (or a removed twist-lock) is to be selected for use in further pinning operations—for instance, pinning operations on containers that are to be loaded onto a vessel following the completion of current pinning operations on containers 10 have been unloaded from the vessel. In some examples, a selected twist-lock may be stored by a classified lock storage system, such as the classified lock storage system 400 described herein, for later use in pinning operations. For instance, a user of the container pinning system 200 and/or container lock management system 100 may select to use a certain range of models and/or types of twist-locks in pinning operations and decide to not use other models and/or types of twist-locks in pinning operations.

Each container pinning station 204 may also be configured to, during pinning operations, determine whether a selected twist-lock is to be placed, by the lock manipulator 210, in a universal lock carrier 700 as described herein. Each container pinning station 204 may also be configured to determine, using the manipulation solution system, and based on the classification and an orientation of a selected twist-lock as determined by the lock identifier 220, a lock manipulation solution that is usable to cause the lock manipulator 210 to move the selected twist-lock to be placed on the universal lock carrier 700.

The lock identifier 220 may comprise a system configured to acquire information relating to the three-dimensional (3D) shape of the twist-lock in, or removed from, the corner block 12 and, based on this information, the lock identifier 220 can classify the twist-lock and/or determination the twist-lock's orientation. For instance, the lock identifier 220 may be provided with access to information relating to the 3D shapes of any number of classifications of twist-locks and, by comparing the acquired information with the accessible information, determine which classification of twist-lock, if any, is a match for the separated twist-lock. In one example, the lock identifier 220 of each container pinning station 204 comprises a machine vision system 222. The machine vision system 222 is configured to acquire one or more images of the area in and around the container pinning station 204. The machine vision system 222 may capture one or more images of the area in the vicinity of the corresponding corner block 12 when a container 10 is located in the container pinning position. The machine vision system 222 may capture one or more images of the area in the vicinity of all possible motion paths of the pinning gripper 800 that can be followed as a twist-lock is handled by the lock manipulator 210.

Once a twist-lock is classified, a determination can be made as to whether the twist-lock classification is one of a predetermined set of twist-lock classifications that a user wishes to select for pinning operations and, in some examples, for storage by a classified lock storage system as described herein. If the selected twist-lock is to be loaded onto a universal lock carrier 700, then the manipulation solution system determines, using an orientation of the selected twist-lock, the motion of the twist-lock needed to move the twist-lock from an identification position (for instance, located within the corner block 12 or held by the lock manipulator 210) to the universal lock carrier 700. For example, the motion may comprise a series of translations and rotations of the twist-lock needed to move the twist-lock onto the universal lock carrier 700. The orientation of the selected twist-lock may be determined by the lock identifier 220, for instance, as and when the twist-lock is identified. The manipulation solution system then calculates a corresponding sequence of motions of the lock manipulator 210 that are needed to cause the motion of the selected twist-lock from the identification position onto the universal lock carrier 700. For example, the sequence of motions may comprise a series of translations and rotations of links that make up the mechanical arm 212 configured to hold and move the selected twist-lock. The manipulation solution system outputs the sequence of motions as a lock manipulation solution.

The manipulation solution system may output the lock manipulation solution as data representing the sequence of motions of lock manipulator 210, wherein the data is usable to control the motions of the lock manipulator 210. The lock manipulator 210 is then operated to transport the selected twist-lock to the universal lock carrier 700 from the identification position. The lock identifier 210 may determine the orientation of the selected twist-lock using, for example, the system configured to acquire information relating to the 3D shape of the twist-lock.

The container pinning station 204 may comprise one or more pinning station controllers 230 to control certain operations of the container pinning station 204 and/or container pinning system 200. For the sake of clarity, only one controller 230 of one of the container pinning stations 204 is illustrated in FIG. 2. However, it will be understood that the one or more controllers 230 may be provided, for instance, centrally as a central control system in the container pinning system 200 (or the container lock management system 100), or separately for each container pinning station 204. The one or more controllers 230 are configured to control the operation of the container pinning station 204, for instance to control the behaviour of the lock manipulator 210 and to communicate with the machine vision system 222. The one or more controllers 230 may comprise a module of the lock identifier 220, which may be configured to manage the lock identifier 220 and/or make determinations concerning twist-locks as is described herein. The one or more controllers 230 may comprise a module of the manipulation solution system, the output of which can be used by the one or more controllers 230 to control the lock manipulator 210. The one or more controllers 230 may be, so as to send and receive control signals, communicatively coupled to the lock manipulator 210 and/or the machine vision system 222. The one or more controllers 230 may be communicatively coupled to one or more stools 600 as described herein. Control modules of the one or more controllers 230 may be located within, or a part of, the lock manipulator 210 and/or machine vision system 222 as determined by operational needs and preferences. The one or more controllers 230 may be configured to, based on captured images from the machine vision system 22, determine the location, orientation, and/or state of the pinning grippers 800 in the three-dimensional space around the container pinning station 204. For instance, the one or more controllers 230 may comprise an image processing module-which may be a control module located within machine vision system 222-to supply data indicative of the location of the gripper 800 within the three-dimensional space. The image processing module may be a part of the lock identifier 220 or supply the data to the lock identifier 220. Based on the location data, the one or more controllers 230 can cause the location, orientation, and/or state of the pinning grippers 800 to be modified, for instance as part of a lock manipulation solution as described herein.

In certain examples, the container pinning station 204 comprises a retrieved lock repository 240 to receive twist-locks that have been retrieved from a container 10 yet are not selected for use in later pinning operations. For instance, an unselected twist-lock may not be of the model or type that is to be used in later pinning operations, may not be identifiable by the lock identifier 220 (due to time constraints or damage, for instance), or may be recognised as unusable due to damage. In some examples, in use, an unselected twist-lock may be removed from a corresponding corner block 12 during pinning operations and the twist-lock delivered to, or discarded in, the retrieved lock repository 240 by the lock manipulator 210. In some examples, once a certain number of twist-locks have been retrieved from containers 10, the retrieved twist-locks may be fed F, as shown in FIG. 1 in the dotted lines, for feeding to the lock classification system 300. Thus, in some cases, where the lock classification system 300 is present, a further attempt at identifying unselected twist-locks may take place. Alternatively, unselected twist-locks may be returned to the vessel, or other source, from which the unselected twist-locks originated. In certain examples, the retrieved lock repository 240 is configured to accommodate a receptacle, such as a lock drop bin 242, where the unselected retrieved locks can be deposited by the lock manipulator 210. Such drop bins 242 can then be moved, for example using a fork-lift or other means, to be fed to the lock classification system 300 or returned to the vessel. The drop bins 242 may be emptied by hand, for example. Additionally, the lock drop bin 242 may be vessel bins that have been delivered from the twist-lock store of a container vessel, for instance. Accordingly, the lock drop bin 242 may be a part of the independent storage facility 40 as described with respect to FIG. 1. Alternatively, or additionally, the lock bins 242 may be part of the unclassified lock storage 500 as described with respect to FIG. 1. It will be understood that the lock drop bin 242 may be one and the same as, or interchangeable with, lock bins 42 described herein. In certain examples, in use, an unselected twist-lock may be left in a corresponding corner block 12 and not removed during pinning operations.

Each container pinning station 204 may comprise one or more carrier stools 600 as described herein. Each carrier stool 600 is configured to releasably support a universal lock carrier 700 as described herein. The carrier stools 600 facilitate pinning operations to be carried out by the container pinning stations 204. A storage input station, storage input/output station, and/or storage output station of a classified lock storage system, as described hereinbelow, may comprise the one or more carrier stools 600. For instance, one or more storage input/output station of a classified lock storage system may comprise the one or more carrier stools 600 so that classified twist-locks can be put into the classified lock storage system at the one or more storage input/output stations and removed from the classified lock storage system at the one or more storage input/output stations whilst loaded on respective universal lock carriers 700.

In certain examples, when the container pinning stations 204 are carrying out pinning operations involving fixing twist-locks to corner blocks 12, classified twist-locks can be delivered to the carrier stool 600 on universal lock carriers 700. In use, when a universal lock carrier 700 carrying the desired classification of twist-lock has been delivered to a carrier stool 600, the lock manipulator 210 is moved to a position where the twist-lock can be picked up from the universal lock carrier 700 by the lock manipulator 210 and moved to a suitable position for fixing to the corner block 12. The twist-lock can then be fitted to the corner block 12 using the lock manipulator 210. The now-empty universal lock carrier 700 is then removed from the carrier stool 600. If required, another universal lock carrier 700 carrying the desired classification of twist-lock can then be placed on the carrier stool 600 so that the container pinning station 204 is ready to conduct the next container pinning operation.

In certain examples, when the container pinning stations 204 are carrying out pinning operations involving removing twist-locks from corner blocks 12, classified twist-locks can be placed on universal lock carriers 700 that have been delivered to the carrier stool 600 for the purpose of receiving classified twist-locks that are to be transported to a classified lock store, such as described herein. In use, an empty universal lock carrier 700 is delivered to a carrier stool 600 in preparation for receiving a classified twist-lock. Once a classified twist-lock has been selected for use in a later pinning operation, the lock manipulator 210, which is already holding the selected twist-lock or has moved to remove the selected twist-lock from the corner block 12, is actuated to move and load the twist-lock on the universal lock carrier 700. The universal lock carrier 700 is then removed from the carrier stool 600 and transported to a location for storage, such as the classified lock store described herein. If required, another empty universal lock carrier 700 can then be placed on the carrier stool 600 so that the container pinning station 204 can deliver another selected twist-lock for storage.

In certain examples, the universal lock carrier 700 may be delivered to and removed from the carrier stool 600 using the carrier transportation system as described herein.

Certain example pinning operation methods and/or processes will now be described. The methods and/or processes may comprise methods and/or processes of twist-lock classification. The methods and/or processes may be performed, executed and/or implemented in any of the example container pinning systems described herein and/or illustrated in any of the figures.

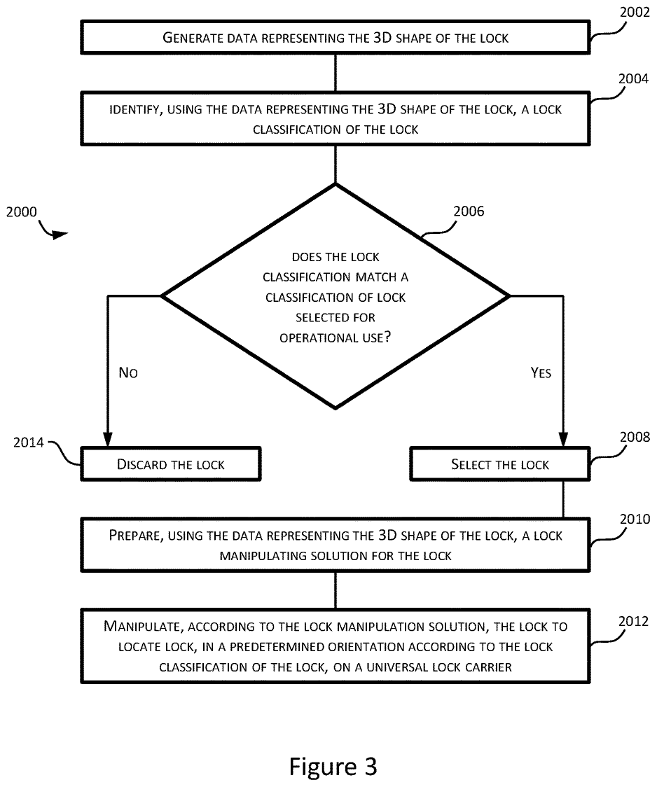

A method 2000 for classifying a twist-lock that is to be removed from, or has been removed from, a container corner block during a pinning operation is shown in the flow diagram of FIG. 3. The method comprises: at block 2002, generating data representing the 3D shape of the twist-lock; and, at block 2004, identifying, using the data representing the 3D shape of the twist-lock, a twist-lock classification of the twist-lock. Based on the twist-lock classification of the twist-lock, a determination is made, at block 2006, as to whether the twist-lock classification matches a classification selected for operational use, for instance in pinning operations. If the twist-lock classification matches the classification selected for operational use the twist-lock is selectable for operational use. At block 2008, the twist-lock is selected for operational use, subject to any other checks that may be performed on the twist-lock.

Generating data representing the 3D shape of the twist-lock may comprise acquiring one or more images of the twist-lock and using the one or more images to create a 3D model of the twist-lock in a simulated 3D space. The one or more images may be acquired by the lock identifier, for example. For instance, the 3D model may be a coordinate-based representation of the twist-lock generated by coordinate mapping the one or more images. Classification of the twist-lock may comprise comparing the 3D model of the twist-lock with other classified 3D models that each represent a particular type or model of twist-lock. For instance, the method may comprise interrogating (using processing circuitry) a storage medium having a database of classified 3D models, each of which represents a different type or model of twist-lock, stored thereon and comparing the 3D model of the twist-lock with each of the classified 3D models to determine if the 3D model of the twist-lock matches any of the classified 3D models. If a match is found, then the twist-lock is considered to meet a classification corresponding to the particular classified 3D model. In certain examples, generating data representing the 3D shape of the twist-lock may include acquiring one or more images of the container corner block in which the twist-lock is, or was, located. Accordingly, the generated data may also represent the 3D shape of the container corner block. The one or more images of the container corner block may be used in creating a 3D model of the container corner block in the simulated 3D space. The one or more images of the container corner block may also be used in creating the 3D model of the twist-lock in the simulated 3D space. The one or more images of the container corner block may be acquired by the lock identifier, for example at the same time as the one or more images of the twist-lock.

In certain examples, selecting the twist-lock for operational use may comprise performing a quality control check on the twist-lock. For instance, the twist-lock may be checked for defects or damage to determine if the twist-lock meets a pre-determined standard. The quality control check may be performed using the data representing the 3D shape of the twist-lock.

The method may comprise, at block 2014, discarding the twist-lock. For instance, the twist-lock may be discarded by virtue of not matching a classification selected for operational use or because the twist-lock does not pass the quality control check. In certain examples, the discarded twist-lock may not be removed from the container corner block during the pinning operation. In other examples, the discarded twist-lock may be removed from the container corner block during the pinning operation and, for instance, delivered to a lock repository as described above.

In certain other examples, all twist-locks that are removed from a corner block of a container may be selected for use in later pinning operations, for instance regardless of a twist-lock classification or of a quality control review.

Once selected, the method may comprise, at block 2010, preparing, using the data representing the 3D shape of the twist-lock, a lock manipulation solution for the twist-lock. At block 2012, the twist-lock is manipulated according to the lock manipulation solution to be placed in a predetermined orientation on a universal lock carrier, such as the universal lock carrier 700 as described herein. The predetermined orientation on a universal lock carrier will depend on the classification of the twist-lock. Generating the lock manipulation solution may utilise the generated data representing the 3D shape of the twist-lock. In certain examples, generating the lock manipulation solution may utilise the generated data representing the 3D shape of the container corner block. For instance, the orientation of the twist-lock, at the point of identification and/or classification may be determined from the generated data representing the 3D shape of the twist-lock and, in some examples, the generated data representing the 3D shape of the container corner block. In one example, the orientation of the twist-lock may be derived from a 3D model representing the twist-lock and a support on which the twist-lock is resting. For example, the 3D model may represent the twist-lock and a corner block in which the twist-lock is located or may represent the twist-lock and the pinning gripper that is holding the twist-lock. In this way, the lock manipulation solution can be prepared such that the lock manipulation can be carried out accurately. For instance, the twist-lock can be removed from a corner block in a known orientation, or an orientation of the twist-lock held by the pinning gripper determined. Generating the lock manipulation solution may also utilise the twist-lock classification since, once classified, the 3D geometry is known. In this way, in some examples, referring to the 3D model of the twist-lock may be minimised thereby reducing the computational effort required to generate the lock manipulation solution.

In one example, identification of the twist-lock classification is based on generating the data representing the 3D shape of the twist-lock from the twist-lock being positioned in a corner block. In other examples, identification of the twist-lock classification may be based on generating the data representing the 3D shape of the twist-lock after the twist-lock has been removed from the corner block. In other words, the identification of the twist-lock may be performed before or after the twist-lock has been removed from the corner block. For instance, images of the twist-lock may be generated whilst the lock is located within the corner block or after the twist-lock has been removed from the corner block such as by a lock manipulator as described herein. Identifying the lock in situ in the corner block prior to removal can help provide a faster removal operation. In some examples, generating images of the twist-lock once initially removed from the corner block may be useful where the corner block obscures the lock identifier view of the twist-lock. Accordingly, the data representing the 3D shape of the twist-lock can be generated with the twist-lock located in the corner block and removal of the twist-lock from a corner block of a container may be performed as part of executing a lock manipulation solution at block 2012 to load the twist-lock on a universal lock carrier. In some examples, the data representing the 3D shape of the twist-lock can be generated with the twist-lock located in the corner block and removal of the twist-lock from a corner block of a container may be performed as part of discarding an unselected twist-lock at block 2014.

Alternatively, the method may comprise removing the twist-lock from a corner block of a container so that the data representing the 3D shape of the twist-lock can be generated, for instance at block 2002.

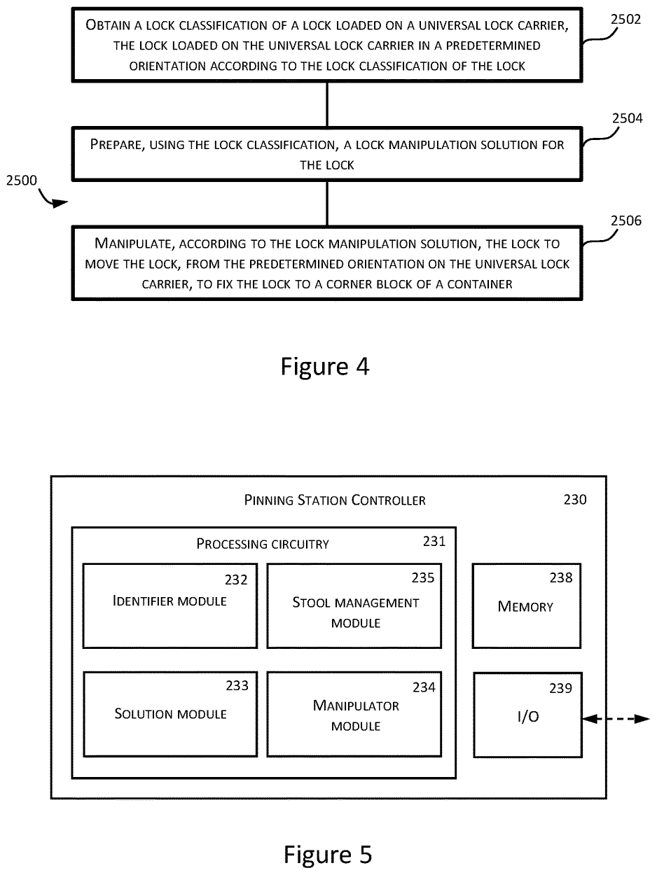

A method 2500 for pinning a classified twist-lock that is to be fixed to, or fitted to, a corner block of a container during a pinning operation is shown in the flow diagram of FIG. 4. The method comprises: at block 2502, obtaining a lock classification of a twist-lock loaded on a universal lock carrier, wherein the twist-lock is loaded on the universal lock carrier in a predetermined orientation according to the lock classification of the twist-lock; at block 2504, preparing, using the lock classification, a lock manipulation solution for the twist-lock; and, at block 2506, manipulating the twist-lock, according to the lock manipulation solution, to move the lock from the predetermined orientation on the universal lock carrier to locate the twist-lock fixedly in the corner block.

In certain examples, the method may comprise delivering the classified twist-lock to a carrier stool on the universal lock carrier and removing the universal lock carrier from the carrier stool once the twist-lock has been unloaded.

In certain examples, the method may comprise obtaining the classification of the twist-lock from an inventory of stored classified twist-locks such as is described herein. For instance, one or more controllers, as described herein, may cause the data indicating the classification of the twist-lock loaded on the universal lock carrier to be sourced from the inventory so that a lock manipulation solution can be generated. In some examples, the method may comprise reviewing a unique identifier of the universal lock carrier and using that unique identifier to confirm the correct universal lock carrier has been delivered to the carrier stool and therefore that the classification of twist-lock loaded on the universal lock carrier is as per the inventory. For example, the method may comprise interrogating a radio-frequency identification (RFID) tag of the universal lock carrier using a RFID reader.

In some examples, since the twist-lock classification is obtained from the inventory information and/or the universal lock carrier and the twist-lock is loaded in a predetermined orientation on the universal lock carrier, the lock manipulation system is able to calculate a lock manipulation solution without resorting to determining the position and orientation of the twist-lock at a starting position loaded on the universal lock carrier. In some examples, the classification, position, and/or orientation of the twist-lock on the universal lock carrier may be verified before the twist-lock is unloaded from the universal lock carrier. For instance, the lock identifier and/or machine vision system described herein may be used to confirm the classification position, and/or orientation of the twist-lock on the universal lock carrier.

In certain examples, the method may comprise generating data representing the 3D shape of the corner block to which the twist-lock is to be fixed. Generating data representing the 3D shape of the corner block may comprise acquiring one or more images of the corner block. The one or more images of the container corner block may be used in creating a 3D model of the container corner block in a simulated 3D space. The one or more images of the container corner block may be acquired by the lock identifier, as described herein. For instance, the 3D model may be a coordinate-based representation of the corner block generated by coordinate mapping the one or more images.

In certain examples, generating the lock manipulation solution may utilise the generated data representing the 3D shape of the container corner block. For instance, the orientation of the twist-lock that will allow the twist-lock to be fixed to the corner block may be determined in part from the generated data representing the 3D shape of the container corner block. In some examples, the generated data representing the 3D shape of the container corner block may be used in combination with the predetermined orientation of the twist-lock on the universal lock carrier (or the verification thereof) to generate the lock manipulation solution. In this way, the lock manipulation solution can be prepared such that the lock manipulation from the universal lock carrier to fixing in the corner block can be carried out accurately.

In some examples, the methods described above, and shown in FIGS. 3 and 4 may be carried out using processing circuitry 231 provided in the pinning station controller 230 of the container pinning station 204 and/or container pinning system 200. The processing circuitry of the controller 230 can cause the blocks described above to be carried out by the container pinning station 204 and/or container pinning system 200 described above. As shown in FIG. 5, the controller 230 may comprise: an identifier module 232; a manipulation solution module 233 of the manipulation solution system; and a lock manipulator module 234. The identifier module 232 is to manage and/or control certain systems of the lock identifier 220 and to make determinations in respect of twist-locks that have been removed from, are to be removed from, or are to be inserted into, a corner block of a container. For example, the identifier module may determine the orientation and/or classification of a particular twist-lock using data representing the 3D shape of the particular twist-lock. The manipulation solution module 233 is to produce and/or manage the output of a lock manipulation solution based on a determined orientation and the classification of a selected twist-lock. The lock manipulator module 234 is to control the lock manipulator 210. It will be understood that the controller 230 may comprise other modules, such as an image processing module. In certain examples, the controller 230 comprises a stool management module 235. The stool management module 235 may perform functions such as monitoring the carrier stool 600 for the presence of a universal lock carrier 700 on the carrier stool 600 and/or monitoring the carrier stool 600 for the presence of a twist-lock on the universal lock carrier 700. For instance, the stool management module 235 may be communicatively coupled to a one or more sensors on the carrier stool 600 that detects the presence of a universal lock carrier 700 on the carrier stool 600 and/or the presence of a twist-lock on the universal lock carrier 700.

The controller 230 may comprise a storage module 238, for instance to store machine readable instructions that are executable by the processing circuitry and/or store data usable by the controller 230. For example, data relating to twist-lock classifications such as a database of 3D models associated with certain twist-lock classifications may be stored on the storage module 238. The controller 230 may comprise a communications interface 239 to communicatively couple the controller 230 to the rest of the container pinning station 204 and/or container pinning system 200.

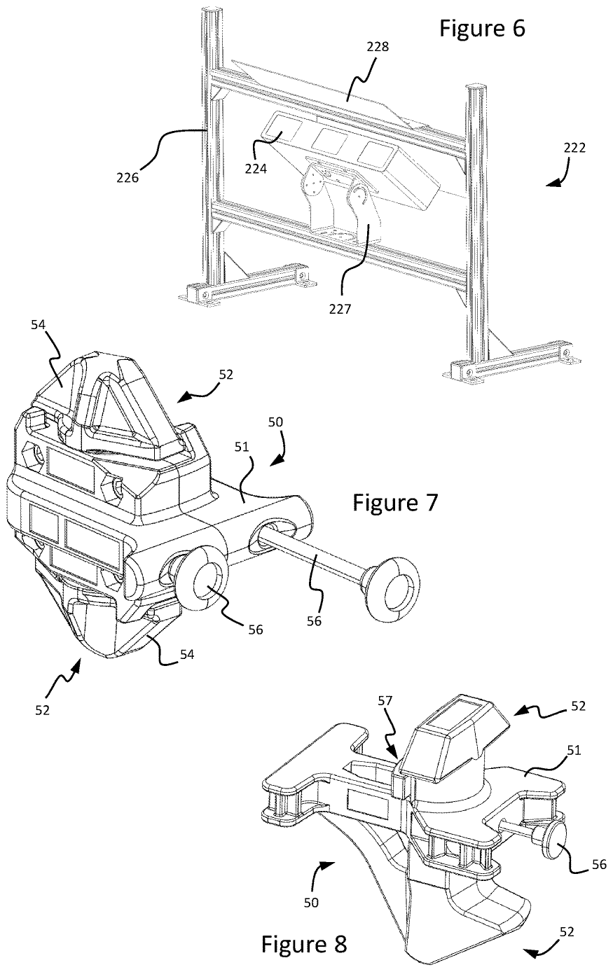

FIG. 6 illustrates one example of a machine vision system 222 that may be deployed in the container pinning system 200. The machine vision system 222 comprises at least one (in the illustrated example, three) image sensor 224 to capture one or more images of the area in and around the container pinning station 204. The one or more image sensors 224 are supported on a frame 226 that permits the machine vision system 222 to be positioned in a suitable location for viewing the area in and around the container pinning station 204, for instance area in the vicinity of the corresponding corner block 12 when a container 10 is in the container pinning position. The one or more image sensors 224 may be supported on the frame 226 via an adjustable bracket 227 that permits the viewing direction of the image sensors 224 to be modified thereby ensuring that the machine vision system 222 is able to be pointed correctly with respect to the of the area in and around the container pinning station 204. The machine vision system 222 may comprise a shield 228 to prevent light spill into the one or more image sensors 224 that may, in some instances, otherwise degrade the captured image quality. The shield 228 may also act to prevent damage to the one or more image sensors 224, for instance by items, such as misplaced twist-locks or universal lock carriers, being dropped from above onto the machine vision system 222.

FIGS. 7 and 8 show examples of twist-locks 50 that may be used in the container lock management system described herein. There are many twist-lock configurations that may be used in the container lock management system and FIGS. 7 and 8 serve to illustrate some particular examples thereof. FIG. 7 shows an example of a semi-automatic twist-lock and FIG. 8 shows an example of a mid-lock.

The twist-lock 50 of FIG. 7 comprises a pair of anchors 52, each of which is usable to releasably lock the twist-lock 50 to a corner block of a container. Each anchor 52 projects from a supporting body 51 and has a shape that is complementary to the shape of the ovaloid slot of a corresponding corner block. In the case of the twist-lock 50 of FIG. 7, each anchor 52 comprises a cam 54 that is movable relative to the supporting body 51 of the twist-lock 50. The twist-lock 50 also comprises one or more lock actuators 56 that are usable to engage and/or disengage one or more of the cams 54 from the respective corner block.

The twist-lock 50 of FIG. 8 also comprises a pair of anchors 52, each of which is usable to releasably lock the twist-lock 50 to a corner block of a container. Each anchor 52 projects from a supporting body 51 and has a shape that is complementary to the shape of the ovaloid slot of a corresponding corner block. In the case of the twist-lock 50 of FIG. 8, each anchor 52 fixed relative to the supporting body 51 of the twist-lock 50. The anchors 52 of the twist-lock 50 are insertable into the ovaloid slot of a corresponding corner block by twisting or otherwise moving the twist-lock 50 relative to the corresponding corner block. The twist-lock 50 of FIG. 8 comprises a lock actuator 56 that is configured to move a slidable cam 57. The slidable cam 57 can be positioned to secure the twist-lock 50 in the corresponding corner block.

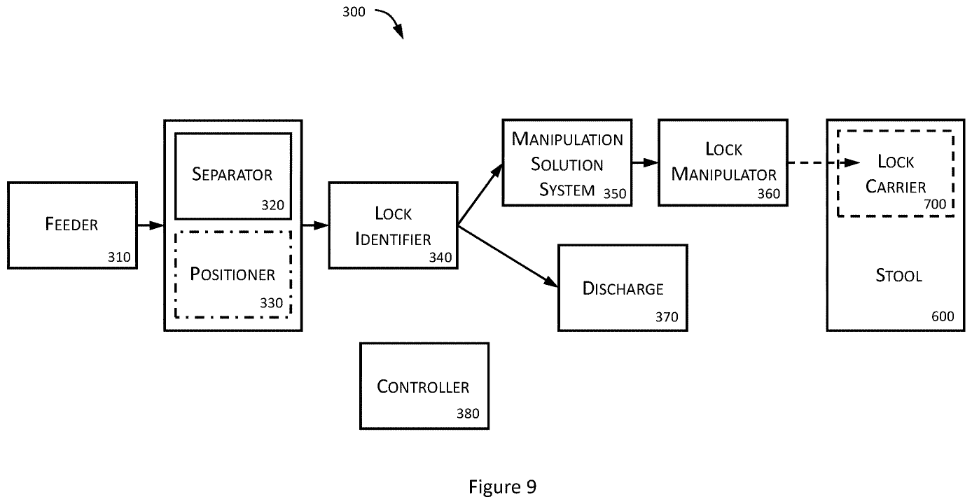

Turning now to FIG. 9, which shows one example of a lock classification system 300. The lock classification system 300 comprises a feeder 310, a lock separator 320, a lock identifier 340, a manipulation solution system 350, and a lock manipulator 360. In some examples, the feeder 310 and the separator 320 are coupled together or are arranged with one or more common components or parts. In other examples, the feeder 310 and the separator 320 are constructed as separate parts of the lock classification system 300. Arrows in FIG. 9 indicate the direction of flow of twist-locks through the lock classification system 300.

The lock classification system 300 is configured to, using the lock identifier 340, classify twist-locks according to type and/or model of twist-lock. The lock classification system 300 is also configured to determine, based on the classification of a twist-lock, whether a twist-lock is to be selected for use in pinning operations. In some examples, a selected twist-lock may be stored by a classified lock storage system, such as the classified lock storage system 400 described herein, for later use in pinning operations. For instance, a user of the lock classification system 300 and/or container lock management system 100 may select to use a certain range of models and/or types of twist-locks in pinning operations. Equally, the user may decide to not use other models and/or types of twist-locks in pinning operations and, thus, desire to sort selected twist-locks from other, non-selected twist-locks. The lock classification system 300 may also be configured to determine whether a selected twist-lock is to be placed, by the lock manipulator 360, in a universal lock carrier 700 as described herein. The lock classification system 300 may also be configured to determine, based on the classification and an orientation of a selected twist-lock as determined by the lock identifier 340, a lock manipulation solution that is usable to cause the lock manipulator 360 to move the selected twist-lock to be placed on the universal lock carrier 700.

In use, twist-locks are fed into the lock classification system 300 via the feeder 310. The lock separator 320 is configured to separate twist-locks from one another so that they can be individually identified by the lock identifier 340. The lock identifier 340 is configured to classify a separated twist-lock passing through the lock classification system 300. The lock identifier 340 may comprise a system configured to acquire information relating to the three-dimensional (3D) shape of the separated twist-lock and, based on this information, the lock identifier 340 can classify the twist-lock. For instance, the lock identifier 340 may be provided with access to information relating to the 3D shapes of any number of classifications of twist-locks and, by comparing the acquired information with the accessible information, determine which classification of twist-lock, if any, is a match for the separated twist-lock.

Once a twist-lock is classified, a determination can be made as to whether the twist-lock classification is one of a predetermined set of twist-lock classifications that a user wishes to select for pinning operations and, in some examples, for storage by a classified lock storage system as described herein. If the selected twist-lock is to be loaded onto a universal lock carrier 700, then the manipulation solution system 350 determines, using an orientation of the selected twist-lock, the motion of the twist-lock needed to move the twist-lock from the present position in the lock classification system 300 to the universal lock carrier 700. For example, the motion may comprise a series of translations and rotations of the twist-lock needed to move the twist-lock onto the universal lock carrier 700. The orientation of the selected twist-lock may be determined by the lock identifier 340, for instance, as and when the twist-lock is identified. The manipulation solution system 350 then calculates a corresponding sequence of motions of the lock manipulator 360 that are needed to cause the motion of the selected twist-lock from the lock classification system 300 on to the universal lock carrier 700. For example, the sequence of motions may comprise a series of translations and rotations of links that make up a mechanical arm configured to hold and move the selected twist-lock. The manipulation solution system 350 outputs the sequence of motions as a lock manipulation solution. The manipulation solution system 350 may output the lock manipulation solution as data representing the sequence of motions of lock manipulator 360, wherein the data is usable to control the motions of the lock manipulator 360. The lock manipulator 360 is then operated to transport the selected twist-lock to the universal lock carrier 700 from the identification position in the lock classification system 300. The lock identifier 340 may determine the orientation of the selected twist-lock using, for example, the system configured to acquire information relating to the 3D shape of the separated twist-lock.

The lock classification system 300 may comprise one or more carrier stools 600 as described herein. Each carrier stool 600 is configured to releasably support a universal lock carrier 700 as described herein. The one or more carrier stools 600 each allow a twist-lock, classified using the lock classification system 300, to be placed on a universal lock carrier 700. In use, an empty universal lock carrier 700 is delivered to the carrier stool 600. A selected twist-lock is then placed onto the universal lock carrier 700. The universal lock carrier 700, loaded with the selected twist-lock, is then removed from the carrier stool 600, for instance for storage by a classified lock storage system as described herein. If required, another empty universal lock carrier 700 may be placed on the carrier stool 600. In certain examples, the universal lock carrier 600 may be delivered to and removed from the carrier stool 600 using a carrier transportation system, such as the carrier transportation system 420 as described herein. A storage input station of a classified lock storage system, as described hereinbelow, may comprise the one or more carrier stools 600. For instance, a storage input station of a classified lock storage system may comprise the one or more carrier stools 600 so that classified twist-locks can be put into the classified lock storage system at the one or more storage input stations whilst loaded on respective universal lock carriers 700.

In certain examples, the lock classification system 300 comprises a positioner 330 configured to position the twist-locks correctly as the twist-locks pass through the lock classification system 300. Controlling the position of the twist-locks within the lock classification system 300 permits the lock identifier 340 to reliably acquire information about a twist-lock passing through the lock classification system 300. In some examples, the positioner 330 is configured to cooperate with the separator 320. For instance, the positioner 330 may be cooperatively coupled to the separator 320.

The lock classification system 300 may comprise a discharge 370. In such examples, where the lock identifier 340 determines that the twist-lock is a non-selected twist-lock, i.e., one that is not to be used in pinning operations, the non-selected twist-lock is expelled from the lock classification system 300 through the discharge 370. Expelling a twist-lock through the discharge 370 may result in the discharged twist-lock being discharged into the unclassified storage 500 described herein. For instance, the discharge 370 may deposit an expelled twist-lock into a removable discharge bin that, once full of expelled twist-locks, can be replaced with another removable discharge bin.

The lock classification system 300 may comprise a classification controller 380 to control certain operations of the lock classification system 300. The controller 380 may be, so as to send and receive control signals, communicatively coupled to one or more of: the feeder 310, the separator 320, the lock identifier 340, and/or the lock manipulator 360. The controller 380 may comprise a module of the lock identifier 340, which may be configured to manage the lock identifier 340 and/or make determinations concerning twist-locks as is described herein. The controller 380 may comprise a module of the manipulation solution system 350, the output of which can be used by the controller 380 to control the lock manipulator 360.

Certain example twist-lock classification methods and/or processes will now be described. The methods and/or processes may be performed, executed and/or implemented in any of the example lock classification systems described herein and/or illustrated in any of the figures.

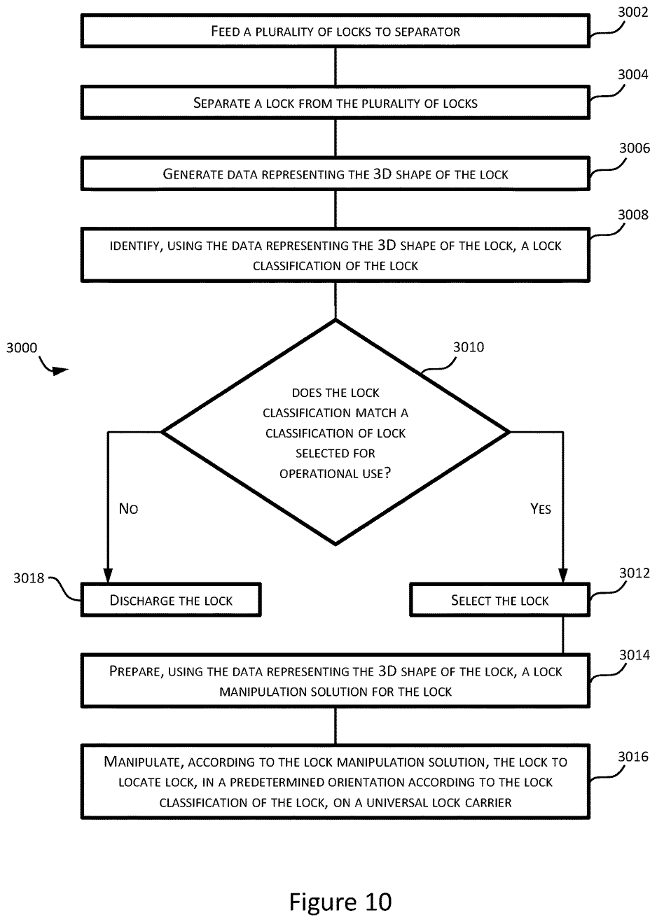

A method 3000 for classifying a twist-lock is shown in the flow diagram of FIG. 10. The method comprises: at block 3002, feeding a plurality of twist-locks to a twist-lock separator; at block 3004, separating a twist-lock from the plurality of twist-locks; at block 3006, generating data representing the 3D shape of the twist-lock; and, at block 3008, identifying, using the data representing the 3D shape of the twist-lock, a twist-lock classification of the twist-lock. Based on the twist-lock classification of the twist-lock, a determination is made, at block 3010, as to whether the twist-lock classification matches a classification selected for operational use, for instance in pinning operations. If the twist-lock classification matches the classification selected for operational use the twist-lock is selectable for operational use. At block 3012, the twist-lock is selected for operational use, subject to any other checks that may be performed on the twist-lock.

Generating data representing the 3D shape of the twist-lock may comprise acquiring one or more images of the twist-lock and using the one or more images to create a 3D model of the twist-lock in a simulated 3D space. The one or more images may be acquired by the lock identifier, for example. For instance, the 3D model may be a coordinate-based representation of the twist-lock generated by coordinate mapping the one or more images. Classification of the twist-lock may comprise comparing the 3D model of the twist-lock with other classified 3D models that each represent a particular type or model of twist-lock. For instance, the method may comprise interrogating (using processing circuitry) a storage medium having a database of classified 3D models, each of which represents a different type or model of twist-lock, stored thereon and comparing the 3D model of the twist-lock with each of the classified 3D models to determine if the 3D model of the twist-lock matches any of the classified 3D models. If a match is found, then the twist-lock is considered to meet a classification corresponding to the particular classified 3D model.

In certain examples, selecting the twist-lock for operational use may comprise performing a quality control check on the twist-lock. For instance, the twist-lock may be checked for defects or damage to determine if the twist-lock meets a pre-determined standard. The quality control check may be performed using the data representing the 3D shape of the twist-lock.

The method may comprise, at block 3018, discharging the twist-lock. For instance, the twist-lock may be discharged by virtue of not matching a classification selected for operational use or because the twist-lock does not pass the quality control check.

Once selected, the method may comprise, at block 3014, preparing, using the data representing the 3D shape of the twist-lock, a lock manipulation solution for the twist-lock. At block 3016, the twist-lock is manipulated according to the lock manipulation solution to be placed in a predetermined orientation on a universal lock carrier, such as the universal lock carrier 700 as described herein. The predetermined orientation on a universal lock carrier will depend on the classification of the twist-lock. Generating the lock manipulation solution may utilise the generated data representing the 3D shape of the twist-lock. For instance, the orientation of the twist-lock, at the point of identification and/or classification may be determined from the generated data representing the 3D shape of the twist-lock. In one example, the orientation of the twist-lock may be derived from a 3D model representing the twist-lock and an identifier support on which the twist-lock is resting. In this way, the lock manipulation solution can be prepared such that the lock manipulation can be carried out accurately, for instance by picking up the twist-lock in a known orientation. Generating the lock manipulation solution may also utilise the twist-lock classification since, once classified, the 3D geometry is known. In this way, in some examples, referring to the 3D model of the twist-lock may be minimised thereby reducing the computational effort required to generate the lock manipulation solution.

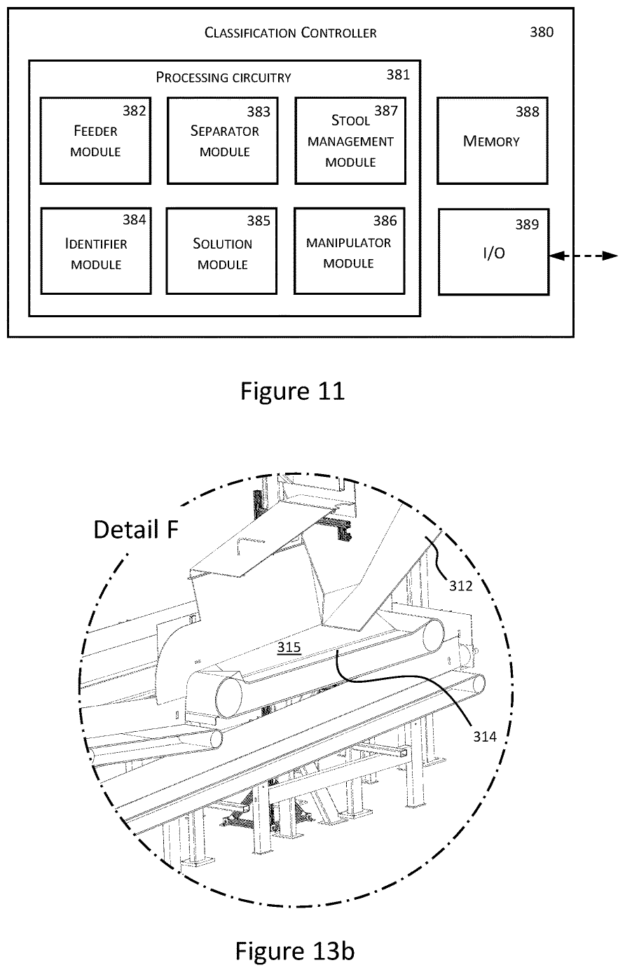

In some examples, the methods described above and shown in FIG. 10 may be carried out using processing circuitry 381 provided in the classification controller 380 of the lock classification system 300 described above. The processing circuitry of the controller 380 can cause the blocks described above to be carried out by the lock classification system 300 described above. As shown in FIG. 11, the controller 380 may comprise: a feeder module 382 to control the feeder 310; a separator module 383 to control the separator 320; an identifier module 384 to manage and/or control certain systems of the lock identifier 340 and to make determinations in respect of twist-locks passing through the lock classification system 300 as described herein, for example determining the orientation and/or classification of a particular twist-lock using data representing the 3D shape of the particular twist-lock; a manipulation solution module 385 of the manipulation solution system 350 to produce and/or manage the output of a lock manipulation solution based on a determined orientation and the classification of a selected twist-lock; and a lock manipulator module 386 to control the lock manipulator 360. The controller 380 may comprise other modules, such as an image processing module, a discharge module to control the discharge 370, and a positioner module to control the positioner 330. In certain examples, the controller 380 comprises a stool management module 387. The stool management module 387 may perform functions such as monitoring the carrier stool 600 for the presence of a universal lock carrier 700 on the carrier stool 600 and/or monitoring the carrier stool 600 for the presence of a twist-lock on the universal lock carrier 700. For instance, the stool management module 386 may be communicatively coupled to one or more sensors on the carrier stool 600 that detects the presence of a universal lock carrier 700 on the carrier stool 600 and/or the presence of a twist-lock on the universal lock carrier 700.

The controller may comprise a storage module 388, for instance to store machine readable instructions that are executable by the processing circuitry and/or store data usable by the controller. For example, data relating to twist-lock classifications such as a database of 3D models associated with certain twist-lock classifications may be stored on the storage module 388. The controller 380 may comprise a communications interface 389 to communicatively couple the controller 380 to the rest of the lock classification system 300.

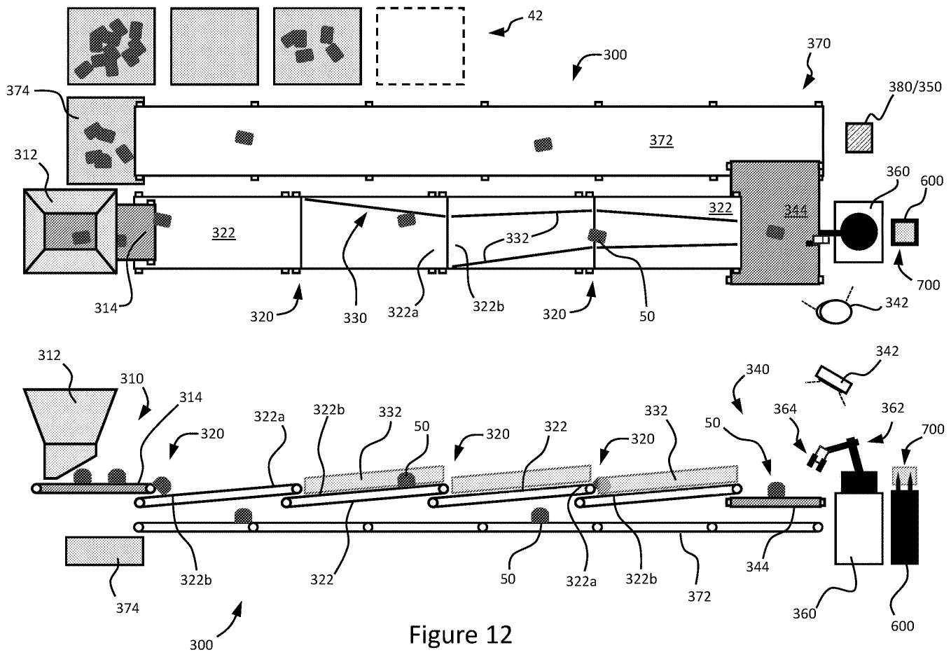

Turning now to FIG. 12, which shows another example of a lock classification system 300. In this example, the lock classification system 300 comprises a series of conveyors that together allow twist-locks to be reviewed and classified when moving through the lock classification system 300. FIG. 12 shows, at the bottom of the page, an elevation view of the lock classification system 300 and, at the top of the page, a plan view of the lock classification system 300. As with the example shown in FIG. 9, the lock classification system 300 comprises a feeder 310, at least one twist-lock separator 320, a lock identifier 340, a manipulation solution system 350, a lock manipulator 360, and a discharge 370. The lock classification system 300 comprises a controller 380, which may comprise one or more of the modules described above with respect to FIG. 11, for example a manipulation solution module of the manipulation solution system 350, the output of which can be used by the controller 380 to control the lock manipulator 360. The lock classification system 300 comprises a carrier stool 600 that is configured to support a universal lock carrier 700 as described herein.

In the example shown in FIG. 12, the feeder 310 comprises a hopper 312 and a feed conveyor 314. As can be seen from the figure, the hopper 312 is tapered and has a lower opening so that twist-locks 50 can be fed, for example by gravity, onto the feed conveyor 314. Twist-locks 50 can be delivered into an upper opening of the hopper 312. For instance, twist-locks 50 can be delivered to the upper opening from lock bins 42 carried by forklifts. A lock bin 42 may be one and the same as, or interchangeable with, discharged lock bin 374 described further below. As FIG. 12 shows, the lock classification system 300 may provide space to accommodate several lock bins 42 to facilitate efficient twist-lock 50 sorting and selection. Alternatively, or additionally, one or more of lock bins 42 may be vessel bins that have been delivered from the twist-lock store of a container vessel, for instance. Accordingly, one or more of the lock bins 42 may be a part of the independent storage facility 40 as described with respect to FIG. 1. Alternatively, or additionally, the lock bins 42 may be part of the unclassified lock storage 500 as described with respect to FIG. 1. As mentioned below, the lock bins 42 may be refilled with twist-locks 50 discharged from the lock classification system 300.

The feed conveyor 314 is arranged to pull the twist-locks 50 from the hopper 312 via the lower opening and then transport the twist-locks 50. The lower opening of the hopper 312 and the feed conveyor 314 are arranged to reduce the possibility of the twist-locks 50 jamming the lower opening as they pass therethrough. Furthermore, the geometry of the lower opening of the hopper 312 is configured to control the rate that twist-locks 50 are delivered onto the feed conveyor 314. For instance, the lower opening of the hopper 312 may have dimensions set at a certain ratio relative to a particular classification of twist-lock. In some examples, a motor, such as a pneumatic motor, is mounted on the hopper 312 and/or the feed conveyor 314 to vibrate the feeder 310 and prevent twist-locks 50 becoming jammed in the lower opening. The motor may be activated continuously during twist-lock classification operations or activated intermittently. For instance, in some examples, the feeder 310 may comprise a jam sensor that is configured to output a signal to the controller 380 that indicates that a jam has occurred at the feeder 310 and the controller 380 may respond by activating the motor. As the feed conveyor 314 draws the twist-locks 50 from the hopper 312, the twist-locks begin the process of being separated. The feed conveyor 314 comprises a bed, such as a belt, on which the twist-locks 50 are delivered from the hopper 312. The bed has a high wear resistance configured to absorb the force of twist-locks 50 landing on the bed and the abrasion from the twist-locks 50 being dragged from the hopper 312. The high wear resistance ensures that the feed conveyor 314 has a long working lifespan.

As can also be seen in FIG. 12, the lock classification system 300 comprises a plurality of separators 320. It will be understood that there may be any suitable number of separators 320, for instance one separator 320 or a plurality of separators 320. In this example, the separators 320 each comprise a first conveyor 314/322a and a second conveyor 322b, each of which is configured to carry twist-locks 50 and arranged immediately adjacent to one another each other. The speed of the second conveyor 322a is higher than the speed of the first conveyor 314/322a. As a twist-lock 50 approaches from the first conveyor 314/322a and makes initial contact with the second conveyor 322b, the second conveyor 322b acts to pull the twist-lock 50 from the first conveyor 314/322a and to accelerate the twist-lock 50 away from the first conveyor 314/322a. In this way, and because more than one twist-lock 50, from a group (i.e., a pile) of twist-locks 50 discharged from the hopper 312, will rarely hit the second conveyor 322b at precisely the same time, each twist-lock 50 will be accelerated away from, and thus separated from, any neighbouring twist-locks 50 in the group. This effect can be multiplied, or compounded, by providing multiple stages of first 314/322a and second conveyors 322b in which a twist-lock 50 is repeatedly accelerated away from any neighbouring twist-locks 50 travelling along the conveyors. The second conveyor 322b may be placed under the end of the first conveyor 314/322a so that the twist-locks 50 drop down onto the second conveyor 322b. This can assist with accelerating the twist-locks 50 away from the first conveyor 314/322a. The second conveyor 322b may overlap first conveyor 314/322a. The second conveyor 322b may be arranged at an angle from the horizontal. Thus, for example, where multiple stages of first 314/322a and second conveyors 322b are used, the conveyors can maintain substantially the same relative vertical position of the twist-locks 50 along the length of the conveyors in the lock classification system 300.

As mentioned above, it will be understood that a single separator 320 may perform the separation process, for instance there may be only one separator 320 defined by the feed conveyor 314 and a single adjacent conveyor. In the actual example shown in FIG. 12, the lock classification system 300 comprises a plurality of separators 320 defined by the feed conveyor 314 and a series of conveyors 322. The twist-locks 50 travel in the direction of left-to-right from the feed conveyor 314 down the series of conveyors 322. Thus, a plurality of separators 320 is provided by the series of conveyors 322 in which each conveyor 322 travels at a higher speed than the preceding conveyor 322. Each conveyor 322 in the series overlaps the previous conveyor 322 and each is inclined at an angle to the horizonal such that a twist-lock 50 travelling along the series of conveyors 322 remains at substantially the same vertical position at the end of the series of conveyors 322 as at the beginning of the series of conveyors 322. It will be understood that not all conveyors 322 may operate at a higher speed than the preceding conveyor 322. Operational preferences may determine that some conveyors 322 may travel at the same speed as the preceding conveyor 322, for example. In some examples, each of the conveyors 322 may be individually speed controlled so as to control the travel of twist-locks 50 through the lock classification system 300. Furthermore, it will be understood that, in certain examples, the feed conveyor 314 is controllable so that the feeding of the twist-locks 50 to the separators 320 can be managed. For instance, the feed conveyor 314 may be stopped and started as necessary and/or the operational speed varied as necessary.

The lock classification system 300 comprises a positioner 330. In the example shown in FIG. 12, the positioner 330 comprises a plurality of diverters 332. In other examples, any suitable number of diverters 332 may be provided, for instance a single diverter 332. The diverters 332 may be any suitable deflector that can be used to move the twist-locks 50 around as they travel along the series of conveyors 322. For instance, the diverters may comprise screens, bumpers, pushers, or ploughs. The diverters 332 act to position the twist-locks 50 correctly so that the lock identifier 340 can function efficiently. As can be seen in the plan view of FIG. 12, the diverters 332 in this example direct the twist-locks 50 as they pass along the conveyors 322 so that they are located centrally on the last conveyor 322 and are therefore accurately located for identification by the lock identifier 340. In the case of the divertors illustrated in FIG. 12, the diverters 332 each comprise a screen that extends along a corresponding conveyor 322 and projects substantially orthogonally from the surface of the corresponding conveyor 332. Contact of a twist-lock 50 with the diverter 332 causes the twist-lock 50 to change position on the conveyor 322, yet still move along the conveyor 322. As can also be seen in FIG. 12, not all conveyors 322 have a corresponding divertor 322 and some conveyors 322 have more than one corresponding diverter 322, for instance so that the diverters 322 act as a funnel for the twist-locks 50. It will be understood that any suitable arrangement of diverters 322 may be implemented according to the positioning requirements of the lock classification system 300.

Once separated, a twist-lock 50 is delivered to the lock identifier 340. For instance, the separated twist-lock 50 may be delivered onto an identifier station or support, which, in this case is an identification conveyor 344. As can be seen in FIG. 12, the last of the conveyors 322 overhangs the identification conveyor 344 so that the separated twist-lock 50 drops onto the onto the identification conveyor 344. The identification conveyor 344 can hold the separated twist-lock 50 until classified and a determination is made as to whether the separated twist-lock 50 is to be selected.

The lock identifier 340 comprises a machine vision system 342, which is communicatively coupled to the controller 380. The machine vision system 342 is configured to acquire one or more images of the area in and around the identifier support, for instance where a twist-lock 50 may be disposed on the identification conveyor 344, in use. The captured images can be used by the lock identifier 340, for instance by the lock identifier module described above, to generate data representing the 3D shape of the separated twist-lock 50. As described above, based on that data, the lock identifier 340 is used to classify the separated twist-lock 50 according to the type and/or model of twist-lock 50 and, based on whether the classified twist-lock 50 is a classification that is to be selected for operational use, determine whether the classified twist-lock 50 should be selected.

If the twist-lock 50 is selected, then the lock manipulator 360 is used to pick up the classified twist-lock 50 from the identifier conveyor 344. The lock manipulator 360 comprises a mechanical arm 362 mounted at a proximal end on base. A movable gripper 364 is attached to a distal end of the mechanical arm 362. The gripper 364 can be moved into position, using the mechanical arm 362, to grip the selected twist-lock 50 and lift it from the identifier conveyor 344. The mechanical arm 362 can then be used to transport the select twist-lock 50, carried by the gripper 342, to deliver the twist-lock 50 to the universal lock carrier 700 temporarily supported on the carrier stool 600. The selected twist-lock 50 is placed on the universal lock carrier 700. The mechanical arm 362 moves the selected twist-lock 50, using the gripper 364, along a path of motion as defined by a manipulation solution that is determined by the manipulation solution system 350 as described herein. To aid in determining the manipulation solution, the machine vision system 342 may capture one or more images of the area in the vicinity of all possible motion paths of the gripper 342 that can be followed as a twist-lock 50 is handled by the lock manipulator 360. The machine vision system 342 may, in some examples, provide real time feedback to the controller 380 regarding the position of the gripper 342 in the 3D area in and around the identifier support and along all possible motion paths of the gripper 342. Alternatively, since the location of the universal lock carrier 700 is known based on the fixed position of the carrier stool 600, the manipulation solution may be determined based primarily on the acquired images of the area in and around the identifier support.

If the twist-lock 50 is not selected, then the twist-lock 50 is discharged from the lock classification system 300 using the discharge 370. The non-selected twist-lock 50 is discharged, in this example, by activating the identifier conveyor 344 so as to move the non-selected twist-lock 50 away from the lock identifier 340. In this case, the identifier conveyor 344 causes the non-selected twist-lock 50 to be moved in a perpendicular direction to the direction of the series of conveyors 322 so that the non-selected twist-lock 50 drops onto a discharge conveyor 372. In this example, the discharge conveyor 372 is a return conveyor that returns the non-selected twist-locks 50 to the vicinity of the feeder 310. The non-selected twist-locks 50 are then dropped into a discharged lock bin 374. It will be understood that the discharged lock bin 374 may be one and the same as, or interchangeable with, the lock bins 42 described above. This arrangement may be helpful by making it easy to manage bins of incoming and outgoing twist-locks 50 all in the area around the feeder 310. For example, discharged twist-locks 50 may then be returned to a vessel in a lock bin 42, fed back into the feeder 310 for re-sorting/classification, or discarded completely depending on operational requirements. It will understood that a return conveyor, or indeed the discharge conveyor 372, may not be provided and, instead, twist-locks 50 that are discharged from the lock identifier 340 may drop into an adjacent bin, for example.

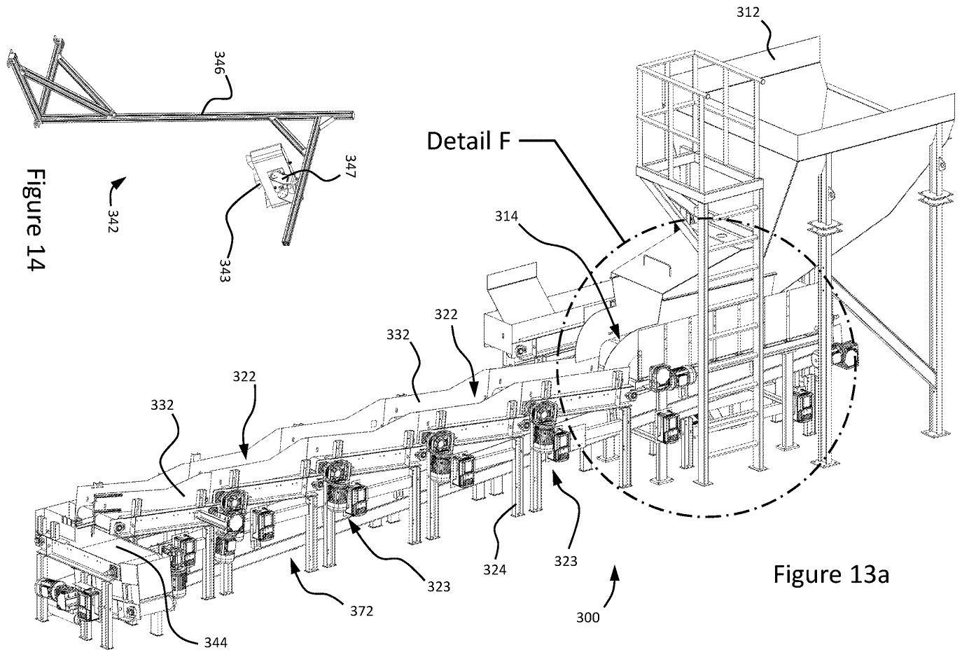

FIGS. 13a and 13b show another example of a lock classification system 300. The lock classification system 300 shown in these figures is arranged in a manner similar to that of FIG. 12 and comprises a series of conveyors that together allow twist-locks to be reviewed and classified when moving through the lock classification system 300. Although not referenced for the sake of illustrative clarity, the lock classification system 300 comprises a feeder 310, at least one twist-lock separator 320, a lock identifier 340, a manipulation solution system 350, a lock manipulator 360, a discharge 370, and a controller 380, which may comprise one or more of the modules described above with respect to FIG. 11. Certain elements of the lock classification system 300 are not illustrated in FIGS. 13a and 13b and the manipulation solution system 350, the lock manipulator 360, and the controller 380 have been omitted entirely. Although also not shown in the figures, the lock classification system 300 may also comprise a carrier stool 600 as described herein. Elements similar to those described with respect to FIG. 12 are referenced with like-numbered references.

As with the example of FIG. 12, each conveyor 322 in the series of conveyors 322 in the lock classification system 300 of FIG. 13a overlaps the previous conveyor 322. Each conveyor 322 is inclined at an angle to the horizonal such that a twist-lock 50 travelling along the series of conveyors 322 remains at substantially the same vertical position at the end of the series of conveyors 322 as at the beginning of the series of conveyors 322. The conveyors 322 are each driven by a conveyor motor 323. A chassis 324 is provided to support the conveyors 322, conveyor motors 323, and other components of the lock classification system 300. In the example shown in FIG. 13a, diverters 332 are provided at each of the conveyors 322.

Detail F from FIG. 13a, which is shown FIG. 13b, is a cross-sectional view of a portion of the feeder of the lock classification system 300. The cross-section is through the longitudinal direction of the feed conveyor 314 (i.e., the direction of travel of twist-locks along the conveyor 314). FIG. 13b illustrates that the feed conveyor 314 may be arranged to assist with separating twist-locks as they are received on the feed conveyor 314 from the hopper 312. In this example, the feed conveyor 314 comprises a feed conveyor guide 315 that acts to channel twist-locks from the hopper 312 into a rough line of twist-locks. The feed conveyor guide 315 comprises a pair of angled guides (the second is not shown in FIG. 13b due to the cross-section) that cause twist-locks that are deposited from the hopper 312 to fall towards the centre of the feed conveyor 314. Due to the presence of the feed conveyor guide 315, twist-locks cannot be dropped from the hopper 312 across a wide area of the feed conveyor 314 and are, instead, channelled towards the centre of the feed conveyor 314. Only those twist-locks on the centre of the feed conveyor 314 are carried forward thus forming a line of twist-locks on the feed conveyor 314.

FIG. 14 is an example of a machine vision system 342 for use in the lock classification system 300 of FIG. 12 or 13a. The machine vision system 342 is arranged to be set above the identifier station so that a suitable image of a twist-lock on the identification conveyor 344 can be obtained. The machine vision system 342 comprises at least one (in the illustrated example, three) image sensor 343 to capture one or more images of the area in and around the identifier station. The one or more image sensors 343 are supported on a frame 346 that permits the machine vision system 343 to be positioned in a suitable location for viewing the area in and around the identifier station, for instance area in the vicinity of the identification conveyor 344 and the areas where the lock manipulator 360 will move a twist-lock to the carrier stool 600. The one or more image sensors 343 may be supported on the frame 346 via an adjustable bracket 347 that permits the viewing direction of the image sensors 343 to be modified thereby ensuring that the machine vision system 343 is able to be pointed correctly with respect to the of the area in and around the identifier station.

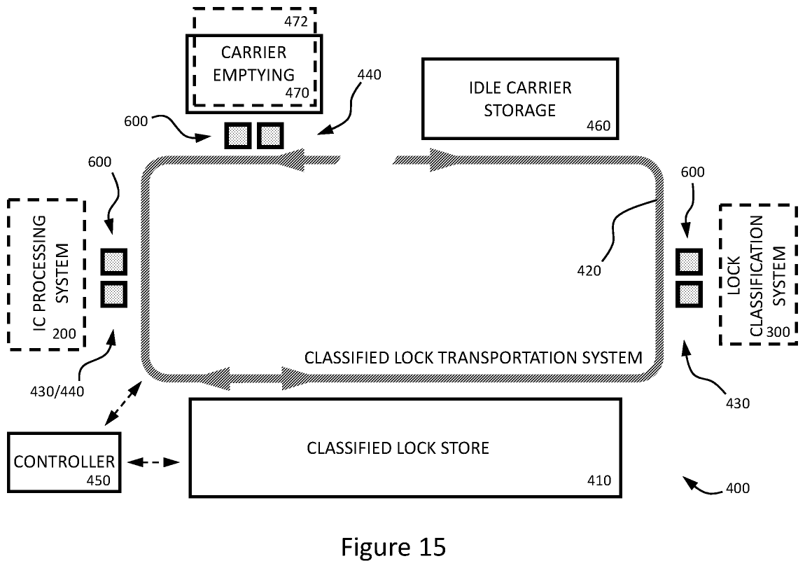

Turning now to FIG. 15, which shows one example of a classified lock storage system 400. The classified lock storage system 400 comprises a classified lock store 410 having a capacity to store a plurality of classified twist-locks. The classified lock store 410 comprises a plurality of storage locations, each of which is configured to temporarily store one classified twist-lock from the plurality of classified twist-locks until the classified twist-lock is retrieved for use in a pinning operation. The classified lock storage system 400 is configured to store the plurality of classified twist-locks in the classified lock store 410 in an organised and traceable manner by maintaining an inventory of stored classified twist-locks according to the classification of twist-lock stored in each storage location. For instance, the classified lock storage system 400 may maintain a record of the type and/or model of twist-lock, if there is one, that is stored in a particular storage location. In this way, particular classifications of twist-locks, which have been selected for use in a pinning operation, can be retrieved accurately and delivered to a pinning operation site, for example a container pinning system 200 as described herein. Since twist-locks of a particular classification can be readily retrieved without any further sorting or checking, the efficiency of pinning operations can be increased.

The classified lock storage system 400 comprises a classified lock transportation system 420. The classified lock transportation system 420 is usable to move twist-locks around the classified lock storage system 400. The classified lock storage system 400 comprises one or more storage input stations 430 and one or more storage output stations 440. A storage input station of the one or more storage input stations 430 and a storage output station of the one or more storage output stations 440 may be provided together as a storage input/output station 430/440, for example at, or in, a container pinning system 200 as described herein. Thus, the classified lock storage system 400 may comprise one or more storage input/output stations 430/440. It will be understood that the classified lock transportation system 420 may comprise any suitable number of storage input stations 430, storage output stations 440, and/or storage input/output stations 430/440. Twist-locks can be put into the classified lock storage system 400 at the one or more storage input stations 430 and removed from the classified lock storage system 400 at the one or more storage output stations 440. Twist-locks can be put into and removed from the classified lock storage system 400 at storage input/output stations 430/440. In the example shown in FIG. 15, the classified lock storage system 400 comprises one storage input station 430, one storage input/output station 430/440, and one storage output station 440; however, any suitable number of storage input stations, storage input/output stations, and/or storage output stations may be provided.

The classified lock transportation system 420 is configured to, in use, receive classified twist-locks from the one or more storage input stations 430 and deliver the classified twist-locks to the classified lock store 410 for storage in one of the storage locations. The classified lock transportation system 420 is configured to, in use, retrieve classified twist-locks from the classified lock store 410 and to deposit the classified twist-locks at the one or more storage output stations 440.

In certain examples, classified twist-locks may be receivable at one of the one or more storage input stations 430 from a corresponding lock classification system 300 as described herein. In the example of FIG. 15, classified twist-locks are receivable at a single storage input station 430 from a lock classification system 300; however, it will be understood that any suitable number of lock classification systems 300, each delivering twist-locks to a corresponding storage input station 430, may be provided.

In certain examples, classified twist-locks may be receivable at one of the one or more storage input/output stations 430 from, or within, a container pinning system 200 as described herein. In the example of FIG. 10, a single storage input/output station 430/440, at which classified twist-locks are receivable from a container pinning system 200, is illustrated. It will be understood, however, that any suitable number of container pinning systems 200, each delivering twist-locks to one or more corresponding storage input/output stations 430/440, may be provided. For instance, as described above, a container pinning system 200 may deliver twist-locks to four storage input/output stations 430/440, each of which corresponds to one corner of a container 10 from which a twist-lock is removed.

In certain examples, retrieved classified twist-locks may be depositable at one or more storage input/output stations 430/440 for use in corresponding container pinning systems 200 as described herein. In the example of FIG. 15, a single storage input/output station 430/440, at which classified twist-locks are depositable for use in a container pinning system 200, is Illustrated. Again, it will be understood that any suitable number of container pinning systems 200, each receiving twist-locks from one or more corresponding storage input/output stations 430/440, may be provided. For instance, as described above, a container pinning system 200 may receive twist-locks at four storage input/output stations 430/440, each of which corresponds to one corner of a container 10 from which a twist-lock is removed.

It will be understood that, in some examples, a container pinning system 200 may be served by one or more storage output stations 440 at which classified twist-locks are depositable for use in the container pinning system 200. In other examples, a container pinning system 200 may be served by one or more storage input stations 430 at which classified twist-locks are receivable from the container pinning system 200. Furthermore, other input stations, other output stations 440, and/or other input/output stations 430/440 may be provided in the classified lock transportation system 420 in addition to any input stations 430, output stations 440, and/or input/output stations 430/440 that each service a corresponding container pinning system 200.

In some examples, the classified lock storage system 400 comprises a lock storage controller 450 to control certain operations of the classified lock storage system 400. The controller 450 may be, so as to send and receive control signals, communicatively coupled to one or more of: the classified lock store 410, the classified lock transportation system 420, the one or more storage input stations 430, the one or more storage output stations, 440, and/or the one or more storage input/output stations 430/440.

In certain examples, the classified lock storage system 400 is configured to manage and store each classified twist-lock using a universal lock carrier 700 as described herein. In such cases, each classified twist-lock to be managed and stored in the classified lock storage system 400 is loaded on a universal lock carrier 700. As described elsewhere herein, a classified twist-lock that is loaded onto a respective universal lock carrier 700 is loaded in a pre-determined relationship with the universal lock carrier 700 such that the classified twist-lock can be assumed to rest in a pre-determined orientation on the universal lock carrier 700. For example, a classified twist-lock that is loaded onto a respective universal lock carrier 700 may be loaded in only one possible pre-determined orientation. Irrespective of the type or model of twist-lock, the universal lock carrier 700 comprises a storage system interface that is the same on all universal lock carriers 700. Thus, as well as allowing for predictable manipulation of a loaded twist-lock due to the known orientation of the twist-lock on the universal lock carrier 700, the common storage system interface on each universal lock carrier 700 allows for simplified handling solution to be implemented in the classified lock storage system 400 meaning that classified twist-locks can be handled and moved within the classified lock storage system 400 without regard to the particular classification of the twist-lock.

In some such examples, each storage location of the classified lock store 410 comprises a berth that is configured to removably receive a universal lock carrier 700. For instance, the classified lock store 410 may comprise one or more substantially vertically arranged stacks of storage berths, each of which can hold one universal lock carrier 700. The universal lock carriers 700 may be slidably receivable into the storage berths, for example. Furthermore, the classified lock transportation system 420 is configured to transport universal lock carriers 700. The classified lock transportation system 420 is configured to transport universal lock carriers 700 from the one or more storage input stations 430 and/or one or more storage input/output stations 430/440 to the classified lock store 410. The classified lock transportation system 420 is configured to transport universal lock carriers 700 from the classified lock store 410 to the one or more storage output stations 440 and/or one or more storage input/output stations 430/440. So as to impart motion to the universal lock carriers 700, the classified lock transportation system 420 compromises a carrier interface that is complementary to, and engages with, the storage system interface of the universal lock carriers 700. In one example, the classified lock transportation system 420 may comprise one or more guided vehicles that are each configured to removably receive and hold a universal lock carrier 700 for transporting.

Each input station 430 may comprise one or more carrier stools 600 as described herein. Similarly, each output station 440 may comprise one or more carrier stools 600 as described herein. Similarly, each storage input/output station 430/440 may comprise one or more carrier stools 600 as described herein. Each carrier stool 600 is configured to releasably support a universal lock carrier 700 as described herein. Thus, classified twist-locks locks can be put into the classified lock storage system 400 at the one or more storage input stations 430 and/or at the one or more storage input/output stations 430/440 and removed from the classified lock storage system 400 at the one or more storage output stations 440 and/or at the storage input/output stations 430/440 whilst loaded on respective universal lock carriers 700. For instance, as described above, classified twist-locks may be loaded on to a universal lock carrier 700 in a lock classification system 300 at the input station 430. Alternatively, classified twist-locks may be received already loaded on a universal lock carrier 700, from a lock classification system 300, at the input station 430. The one or more carrier stools 600 of a storage input station 430, which support universal lock carriers 700, may be the same carrier stool(s) 600 of a lock classification system 300 as described above. Thus, it will be understood that the classified lock storage system 400 and the lock classification system 300 may have and use common carrier stool(s) 600. Similarly, classified twist-locks may be deposited, loaded on a universal lock carrier 700, at one of the one or more storage input/output stations 430/440, for use in container pinning system 200. The one or more carrier stools 600 of a storage input/output station 430/440, which support universal lock carriers 700, may be the same carrier stool(s) 600 of a container pinning system 200 as described above. Thus, the classified lock storage system 400 and the container pinning system 200 may have and use common carrier stool(s) 600.

Since universal lock carriers 700 will not always be loaded with a classified twist-lock, or be in use at a particular time, the classified lock storage system 400 may, in some examples, comprise an idle carrier store 460. The idle carrier store 460 is configured to store universal lock carriers 700 when not in use elsewhere in the classified lock storage system 400. The classified lock transportation system 420 is configured to transport universal lock carriers 700 to the idle carrier store 460, for instance, from the one or more storage output stations 440 and/or the one or more storage input/output stations 430/440. For example, a universal lock carrier 700 may be empty after depositing a twist-lock at a storage output station 440 but not immediately be required for use at an input station 430 and therefore can be stored for later use. The idle carrier store 460 may comprise a plurality of empty carrier berths, each of which is configured to removably receive a universal lock carrier 700 for idle storage. For instance, the idle carrier store 460 may comprise one or more substantially vertically arranged stacks of empty carrier berths, each of which can hold one empty universal lock carrier 700. The universal lock carriers 700 may be slidably receivable into the empty carrier berths, for example. Empty carrier berths may not occupy as large a volume as the storage berths described above because the idle universal lock carriers 700 are not loaded with twist-locks. In some other examples, the classified lock store 410 may be configured to store universal lock carriers 700 when not in use elsewhere in the classified lock storage system 400. For instance, empty universal lock carriers 700 may be berthed in the classified lock storage system along with universal lock carriers 700 that are loaded with classified twist-locks.

As mentioned above, other output stations 440 may be provided. As can be seen in FIG. 15, in addition to any storage input/output stations 430/440 that each service a corresponding container pinning system 200 and where twist-locks can be removed from the classified lock storage system 400, the classified lock storage system 400 may comprise a carrier emptying station 470 where classified twist-locks are unloadable from universal lock carriers 700. In certain operations, it may be desirable to empty universal lock carriers 700 of twist-locks. For instance, a new pinning operation may be initiated that needs to use a different classification of twist-lock from those that were stored for a preceding pinning operation. Likewise, a pinning operation for a particular vessel may be complete and the twist-locks that have been removed from the vessel during pinning operations will need to be returned to the vessel before the vessel sails. Alternatively, concurrent pinning operations may be being performed at separate container pinning systems 200 and the classified lock store 400 may have run out of storage locations to store a desired number of twist-locks of different classifications. In such circumstances, some, or all, of the universal lock carriers 700 may need to be emptied of their payload. Unloaded universal lock carriers 700 can be returned, using the classified lock transportation system 420, to the idle carrier store 460 or to a storage input station 430 ready to receive another twist-lock. Unloading a classified twist-lock at the carrier emptying station 370 may result in the unloaded twist-lock being unloaded into the unclassified storage 500 described herein. For instance, unloading at the carrier emptying station 470 may deposit an unloaded twist-lock into a removable unloaded lock bin 472 that, once full of unloaded twist-locks, can be replaced with another removable unloaded lock bin 472. It will be understood that the unloaded lock bin 472 may be one and the same as, or interchangeable with, the lock bins 42 described above. Thus, unloaded twist-locks may be returned to a vessel in a lock bin 472, fed back into the lock classification system 300 for re-sorting/classification, or discarded completely depending on operational requirements.

The classified lock transportation system 420 may be arranged in any suitable configuration to service the classified lock store 410, the storage input stations 430, the storage input/output stations 430/440, the storage output stations 440, and the idle carrier store 460. For example, the classified lock transportation system 420 may form a loop around which the stores 410, 460 and the stations 430, 430/440, 440 may be arranged in any suitable configuration. For instance, a guided vehicle may travel around the loop transporting universal lock carriers 700, in use. In another arrangement, the classified lock transportation system 420 may be arranged along a line where one the stores 410, 460 or the stations 430, 440 is arranged at each end of the line, such as the arrangement shown in FIG. 15.

In use, classified twist-locks are received at the one or more input stations 430 and are transported, by the classified lock transportation system 420, to the classified lock store 410 for storage. An inventory of twist-locks that are managed by the classified lock storage system 400 is updated as twist-locks are introduced into the classified lock storage system 400. Updating the inventory may include recording the classification of a twist-lock stored in a particular storage location in the classified lock store 410. On demand, for instance in response to a request for a particular classification of twist-lock to be delivered to a container pinning system 200 for use in a pinning operation, a stored twist-lock of that classification is identified, from the inventory, and then retrieved from the classified lock store 410. The identified twist-lock is then transported, by the classified lock transportation system 420, to one of the one or more storage input/output stations 430/440. The inventory is updated once a twist-lock has been removed from the classified lock storage system 400.

In certain examples, the classified twist-locks are put into, stored in, and removed from the classified lock storage system 400 on a universal lock carrier 700 as described above. In some such examples, the inventory of classified twist-locks may include information detailing a temporary link between a specific universal lock carrier 700 and the classification of a twist-lock presently loaded on the specific universal lock carrier 700. This inventory information may be maintained and stored by the controller 450 as described further below. The controller 450 may keep track of the movements of a universal lock carrier 700 within the classified lock storage system 400, for instance through a list of movement instructions for the universal lock carrier 700 that have been issued by the controller 450 as the universal lock carrier 700 is managed in the classified lock storage system 400. By keeping track of the movements of the universal lock carrier 700, the controller 450 may monitor the location of the universal lock carrier 700, whether a twist-lock is loaded on the universal lock carrier 700, and the classification of such a twist-lock.

In some examples, to assist with the maintenance of the inventory of classified twist-locks, each universal lock carrier 700 may comprise a unique identifier linked only with that universal lock carrier 700. For example, each universal lock carrier 700 may comprise a radio-frequency identification (RFID) tag that can be interrogated by one or more RFID readers distributed across the classified lock storage system 400. In some examples, RFID readers are provided at the storage input stations 430, storage input/output stations 430/440, and/or storage output stations 440. Other identification systems could equally be used, such as machine-readable optical labels applied to the universal lock carriers 700—for instance, barcodes and quick response (QR) codes. The unique identifiers permit the universal lock carriers 700 to be tracked or identification validated across the classified lock storage system 400.

In some examples, the inventory of classified locks can be updated by reading the RFID tag of the universal lock carrier 700 at the point where a twist-lock is loaded or unloaded from the universal lock carrier 700. In other examples, where the controller 350 maintains full record of the location of particular universal lock carriers 700 within the classified lock storage system 400 based on the controlled movements of the universal lock carriers 700 around the system 400, the RFID tag is usable to validate the status of the inventory at particular points around the system 400, such as the output stations 440.

In use, when a universal lock carrier 700 that is loaded with a classified twist-lock is put into the classified lock storage system 400 at the one or more storage input stations 430, the inventory can be updated to include a record that associates that universal lock carrier 700 with the particular classification of the twist-lock, for instance by using the identifier of that universal lock carrier 700. Furthermore, when that universal lock carrier 700, loaded with the classified twist-lock, is received in one of the storage locations, the inventory can be updated to include a record that associates that universal lock carrier 700 with the particular storage location. In this way, records of where particular classifications of twist-lock are stored within the classified lock store 410 can be maintained. Each storage location may comprise a storage address that is usable to identify the storage location, for instance in the record associating the universal lock carrier 700 with the storage location.

In response to a request for certain classifications of twist-locks to be delivered for pinning operations, the inventory can be consulted to find, from the records that associate the universal lock carriers 700 (loaded with suitably classified twist-locks) with storage locations, a storage location having a universal lock carrier 700 that matches the request. That universal lock carrier 700 can then be retrieved from the storage location of the classified lock store 410 and delivered to the output station 440 for use in the pinning operations. Once the universal lock carrier 700 is retrieved from the storage location, the inventory can be updated to remove, or archive, the record that associates that universal lock carrier 700 with the particular storage location. Likewise, once the classified twist-lock is removed from the universal lock carrier 700, the inventory can be updated to remove, or archive, the record that associates that universal lock carrier 700 with the particular classification of the twist-lock.

As mentioned above, in certain situations some universal lock carriers 700 are to be emptied of classified twist-locks. In response to a determination that certain classifications of twist-locks are to be unloaded from the carrying universal lock carriers 700, the inventory can be consulted to find, from the records that associate universal lock carriers 700 (loaded with suitably classified twist-locks) with storage locations, the storage locations that have universal lock carriers 700 match the request. Those universal lock carriers 700 can then be retrieved from the storage locations and delivered to the output station 440 for emptying. Again, once the classified twist-locks have been emptied from the universal lock carriers 700, the inventory can be updated to remove, or archive, the records that associates those universal lock carriers 700 with the particular classification of twist-lock.

Certain example twist-lock storing methods and/or processes will now be described. The methods and/or processes may be performed, executed and/or implemented in any of the example classified lock storage systems described herein and/or illustrated in any of the figures.

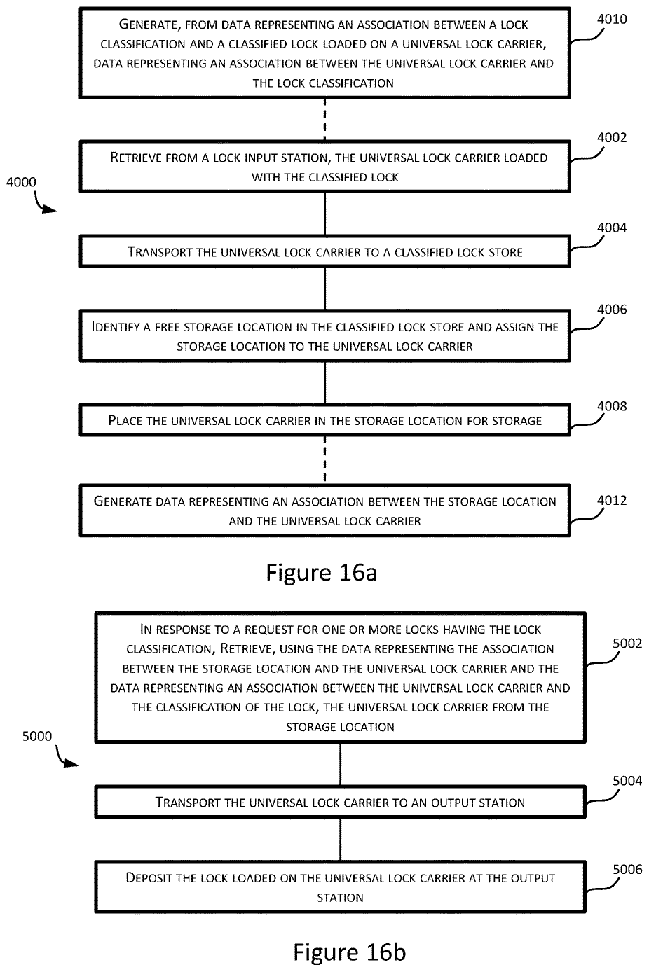

A method 4000 for managing a twist-lock in a classified lock storage system is shown in the flow diagram of FIG. 16a. The method comprises: at block 4002, retrieving, from an input station (or an input/output station), a universal lock carrier loaded with a classified twist-lock; at block 4004, transporting the universal lock carrier to a classified lock store; at block 4006, identifying a free (empty) storage location in the classified lock store and assigning the storage location to the universal lock carrier; and, at block 4008, placing the universal lock carrier in the storage location. Retrieving the universal lock carrier loaded with the classified twist-lock may comprise retrieving the universal lock carrier from a container pinning system or a lock classification system as described herein.

The method may comprise, at block 4010, generating data representing an association between the universal lock carrier and a classification of the twist-lock, wherein the data is generated based on, or from, data representing an association between the classification and the twist-lock loaded on the universal lock carrier. For instance, the data representing an association between the classification and the twist-lock loaded on the universal lock carrier may have been generated by a container pinning system or a lock classification system, as described herein. The data may be additionally generated based on a unique identifier linked only with the universal lock carrier. The data representing an association between the universal lock carrier and a classification of the twist-lock may be recorded in an inventory database, which may be accessible to one or more controllers as described herein.

The method may comprise, at block 4012, generating data representing an association between the storage location and the universal lock carrier placed therein. The data may be generated based on the unique identifier linked only with the universal lock carrier and/or a storage address that is usable to identify the storage location. The data representing an association between the storage location and the universal lock carrier may be recorded in the inventory database, which may be accessible to one or more controllers as described herein.

Another method 5000 for managing a twist-lock in a classified lock storage system is shown in the flow diagram of FIG. 16b. The method comprises, at block 5002, retrieving, using the data representing the association between the storage location and the universal lock carrier placed therein and the data representing an association between the universal lock carrier and the classification of the twist-lock, the universal lock carrier from the storage location.

Retrieving the universal lock carrier may be in response to a request for one or more locks having the classification of the twist-lock. The request may, for instance, relate to twist-locks of the classification being selected for use in a pinning operation. The method comprises, at block 5004, transporting the universal lock carrier to an output station (or an input/output station) and, at block 5006, depositing the twist-lock loaded on the universal lock carrier at the output station (or the input/output station). Depositing the twist-lock at the output station (or the input/output station) may comprise delivering the twist-lock to a container pinning system, as described herein, for use in pinning operations. The recorded data representing an association between the universal lock carrier and a classification of the twist-lock and the recorded data representing an association between the storage location and the universal lock carrier may be updated, deleted, or archived in/from the inventory database.

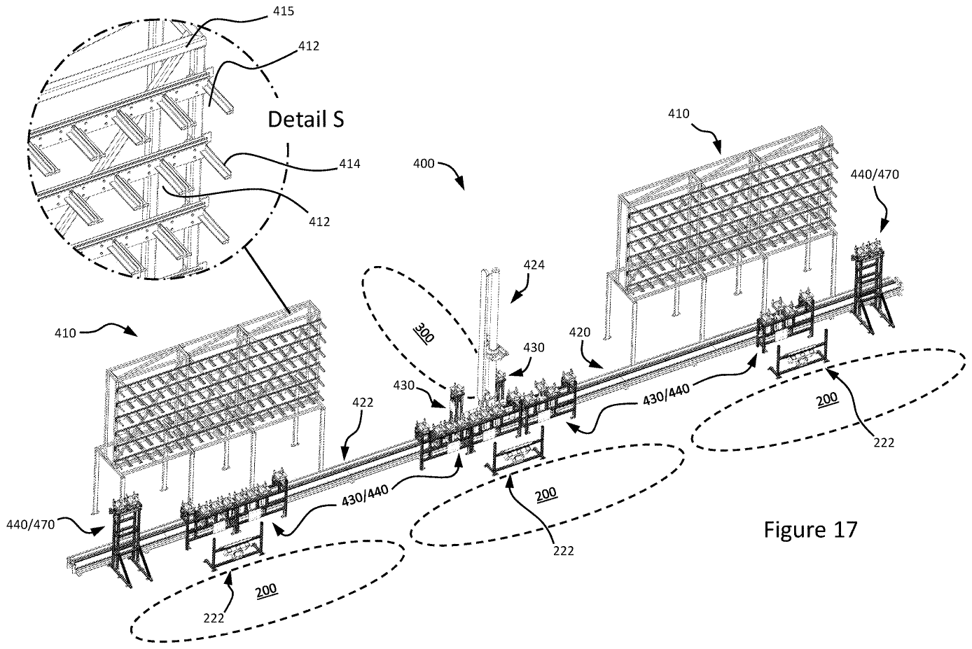

FIG. 17 shows another example of a classified lock storage system 400. The classified lock storage system 400 comprises a classified lock store 410 that is arranged in two separate twist-lock depositories. More depositories may be provided, if desired. The classified lock storage system 400 comprises a classified lock transportation system 420 that is usable to move twist-locks around the classified lock storage system 400.

In this example of the classified lock storage system 400, the classified lock transportation system 420 has a substantially linear arrangement in which the two depositories for twist-lock storage are located at substantially opposing ends of the classified lock transportation system 420. Classified twist-locks are transported along a line between the two depositories and storage input stations 430, storage input/output stations 430/430 and storage output stations 440 that are also arranged along the linearly arranged classified lock transportation system 420. This arrangement may be useful in that the classified lock storage system 400 can be arranged along one side of a container to provide pinning operations on that side of the container. As FIG. 17 shows, the classified lock storage system 400 can interface with one or more container pinning systems 200 as described herein. In this instance, the classified lock storage system 400 is arranged to service three container pinning systems 200 that are arranged adjacent to each other. For the sake of context, FIG. 17 also illustrates machine vision systems 222 for capturing images of corner blocks of respective containers when the container pinning systems 200 are in use. In this example, a single machine vision system 222 services a single container pinning system 200. In other examples, although machine vision systems may be provided to service more than one pinning system 200 instead. In some examples, a duplicate and mirrored classified lock storage system 400 can be provided on the other side of the container pinning systems 200 to service the opposite sides of the containers 200.

To service the container pinning systems 200, this example of the classified lock storage system 400 is provided with four storage input/output stations 430/440 that permit twist-locks to be added to or removed from the classified lock storage system 400 in the manner described above. A different number of storage input/output stations 430/440 may be deployed in other arrangements.

As FIG. 17 shows, the classified lock storage system 400 can interface with one or more lock classification systems 300 as described herein. In this instance, the lock classification system 300 is arranged on the opposing side of the classified lock transportation system 420 to the container pinning systems 200. In this example, the classified lock storage system 400 is provided with two storage input stations 430 that permit twist-locks to be added to the classified lock storage system 400 from the lock classification system 300.

The classified lock transportation system 420 is also comprises two carrier emptying stations 470 (i.e., storage output stations 440) where classified twist-locks are unloadable from universal lock carriers 700. The two carrier emptying stations 470 are located at substantially opposing ends of the classified lock transportation system 420.

Detail S shows the storage locations of one of the classified lock store 410 depositories. The storage locations comprise a plurality of storage berths 412. The plurality of storage berths 412 are arranged in columns and rows. Each storage berth 412 can hold one universal lock carrier 700. In this example, the storage berths 412 each comprise a pair of opposing angle bars 414 that are spaced apart appropriately such that a universal lock carrier 700, as described below, is slidably receivable into the storage berth 412. The opposing angle bars 414 of the storage berths 412 are attached to a supporting frame 415 of the classified lock store 410 depositories.

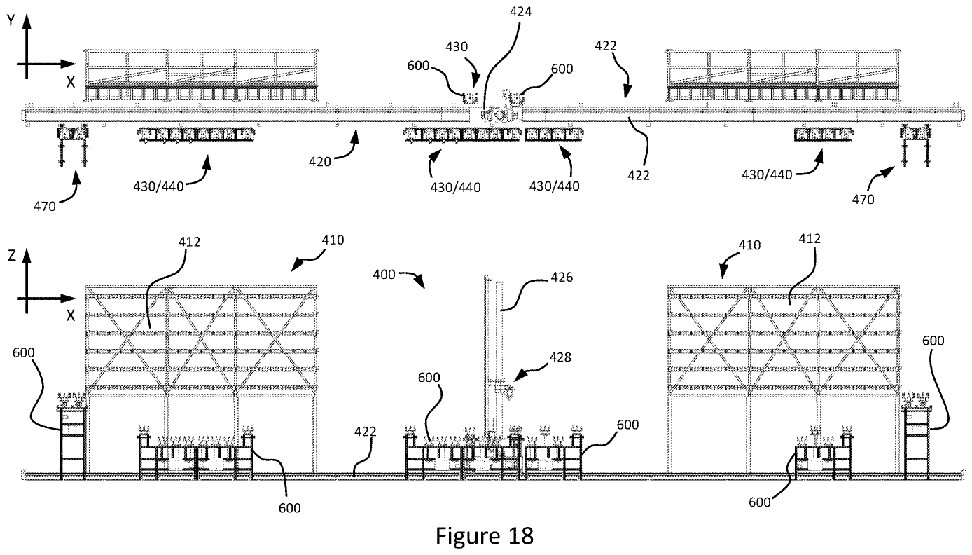

For additional context, FIG. 18 shows an elevation and a plan view of the classified lock storage system of FIG. 17. For the sake of clarity, the machine vision systems 222 of the container pinning systems 200 that are shown in FIG. 17 are not shown in FIG. 18. As can be seen from FIG. 18, each of the storage input stations 430, storage input/output stations 430/430 and carrier emptying stations 470 each comprise a carrier stool 600, as described herein. The carrier stools are configured to releasably support one or more universal lock carriers 700 as described herein. FIG. 18 also illustrates how the supporting frames 415 of the classified lock store 410 depositories are configured to elevate the storage berths 15 and provide clearance beneath the classified lock store 410 depositories.

FIG. 18 also shows the linear arrangement of the classified lock transportation system 420. The classified lock transportation system 420 comprises a guide 422 that extends linearly in an X-direction. The classified lock transportation system 420 comprises a guided vehicle 424 that is movable along the length of the guide 422 so that each of the storage input stations 430, storage input/output stations 430/430 and carrier emptying stations 470 can be accessed by the guided vehicle 424. The guided vehicle 424 comprises a lift module 426 that is configured to, in use, lift a carrier handler 428 up and down in a Z-direction so that universal lock carriers 700 can be placed into the storage berths 412 of the classified lock store 410 and be placed on the carrier stools 600 by the carrier handler 428. As described further below, the carrier handler 428 may be configured to, in use, move a universal lock carrier 700 laterally of the guide 422 (i.e., in a Y-direction) to perform placing operations. Thus, with a combination of movement along the guide 422, movement up and down using the lift module 426, and movement laterally using the carrier handler 428, universal lock carriers 700 can be moved around the classified lock storage system 400.

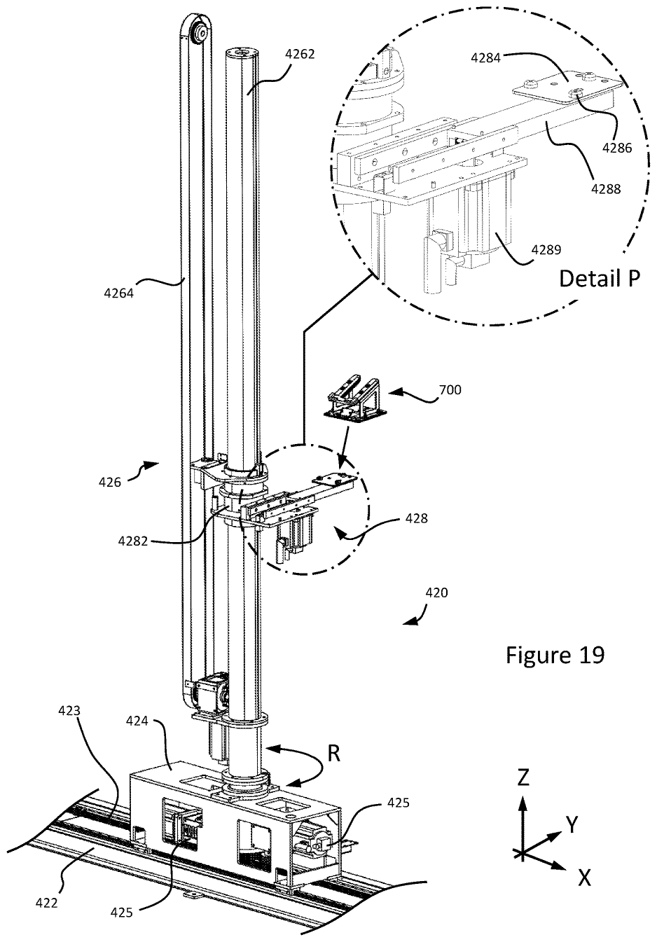

Turning to FIG. 19, which shows a more detailed view of the classified lock transportation system 420 of the classified lock storage system 400. In the example shown, the guide 422 comprises a pair of guide rails on which the guided vehicle 424 can run. The guided vehicle 424 is driveable along the guide 422 by a driven pinion that engages with a rack 423; other arrangements may be employed to impart motion to the guide vehicle 424.

The lift module 426 comprises a mast 4262 that projects upwardly from, and is mounted to, a body of the guided vehicle 434. The mast 4262 is rotatable R, relative to the body, about an axis that extends in the Z-direction. By rotating the mast 4262, the carrier handler 428 can be moved into a position where the carrier handler 428 can service both sides of the classified lock transportation system 420 (i.e., both sides of the guide 422). The guided vehicle 424 may comprise one or more vehicle motors 425 that, in use, drive the pinion to cause motion of the guided vehicle 424 along the guide 422 and drive the rotation of the mast 4262.

The carrier handler 426 comprises a sleeve 4282 that is slidably mounted to the mast 4262. The sleeve 4282 acts to guide the carrier handler 426 along the length of the mast 4262. The lift module 426 comprises a chain drive 4264 that is mounted to the mast 4262. The sleeve 4282 is fixed to a chain of the chain drive 4264 so that, in use, movement of the chain causes the sleeve 4282 to move up and down along the mast 4262. Other arrangements may be employed to drive the carrier handler 426 such as a belt drive or linear actuator, for example. The mast 4262 and the chain drive 4264 may have suitably configured wiring harnesses to permit the transfer of power and/or control signals to the components of the lift module 426 and carrier handler 426.

Detail P illustrates the carrier handler 426 in more detail. The carrier handler 426 comprises a carrier interface 4284 that is configured to support a universal lock carrier as the universal lock carrier is transported within the classified lock storage system 400. The carrier interface 4284 is configured to be complementary to, and engage with, a storage system interface of the transported universal lock carrier.

In the example shown in FIGS. 17 to 19, the carrier interface 4284 is configured to interface with the storage system interface 720 of the universal lock carrier 700 described hereinbelow. The carrier interface 4284 comprises a horizontally oriented flat plate that is configured to mate with the universal lock carrier 700 base plate 724. The carrier interface 4284 also comprises three orientation protrusions 4286 that extend upwardly from the flat plate. The orientation protrusions 4286 are arranged in a substantially triangular configuration. Each of the orientation protrusions 4286 is configured to engage with a corresponding orientation slot 724 in the base plate 724 of the universal lock carrier 700. The orientation protrusions 4286 ensure that the universal lock carrier 700 is located correctly on the carrier interface 4284 so that the universal lock carrier 700 can be reliably positioned on a carrier stool 600 or in a storage berth 412.

The carrier handler 426 comprises an extendible arm 4288 that is slidably connected to the sleeve 4282. The carrier interface 4284 is mounted on the end of the extendible arm 4288. Extending the extendible arm 4288 relative to the sleeve 4282 permits the carrier interface 4284 to be moved in the Y-direction so that the carrier interface 4284 can deliver a universal lock carrier into a storage berth 412 or onto a carrier stool 600. The final delivery motions required of the classified lock transportation system 420 may involve also moving the carrier interface 4284 in the Z-direction to complete the placing of the universal lock carrier into a storage berth 412 or onto a carrier stool 600. A small amount of movement of the carrier interface 4284 in the Z-direction may act to release the universal lock carrier from carrier interface 4284, for instance by lifting the universal lock carrier off the flat plate and over the orientation protrusions 4286. The small amount of movement of the carrier interface 4284 may be imparted by the chain drive 4264. In the example shown in FIGS. 17 to 19, extending and retracting the extendible arm is activated by an arm motor 4289.

In some examples, the methods described above, and shown in FIGS. 16a and 16b may be carried out using processing circuitry 451 provided in the lock storage controller 450 of the classified lock storage system 400 described above. The processing circuitry 451 of the controller 450 can cause the blocks described above to be carried out by the classified lock storage system 400 described above. The controller 450 comprises: a transportation control module 452 to control the classified lock transportation system 420; and an inventory management module 453 to maintain an inventory of classified twist-locks that are managed and stored by the classified lock storage system 400. In some examples, the inventory management module 453 is configured to maintain records of associations between a universal lock carrier and a classification of a twist-lock loaded on the universal lock carrier and between a storage location of the classified lock storage system and the universal lock carrier. In some examples, the inventory management module 453 is configured to perform allocations of storage locations to particular universal lock carriers. For instance, the inventory management module 453 may assign, using a storage address, a storage location, to a universal lock carrier. It will be understood that the controller 450 may comprise other modules according to operational needs.

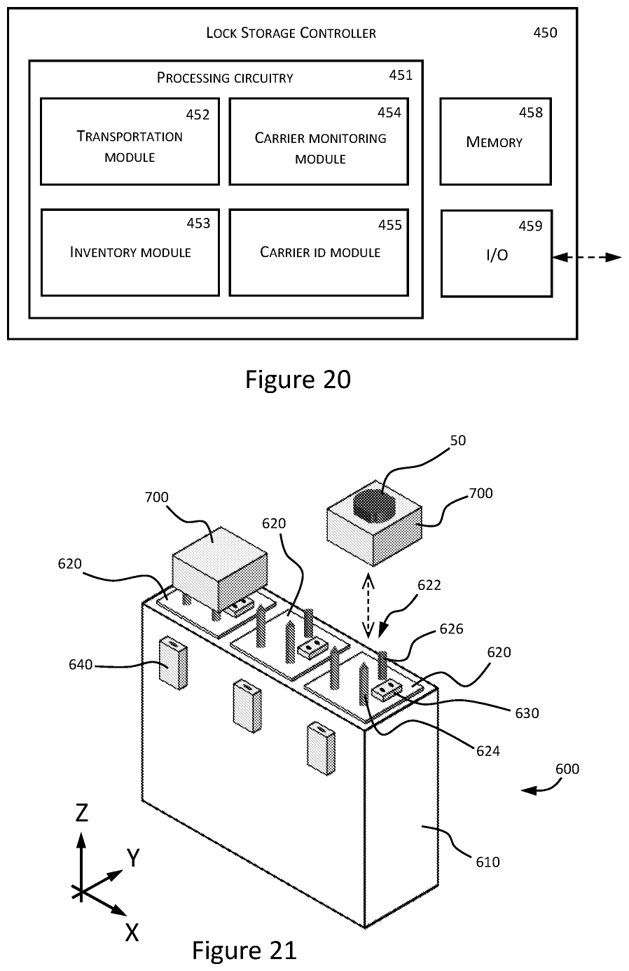

As shown in FIG. 20, the controller 450 may also comprise a carrier monitoring module 454 configured to monitor the location of universal lock carriers within the classified lock storage system 400. For instance, the carrier monitoring module 454 may communicatively connected to one or more sensors of the classified lock storage system 400. Suitable locations for the one or more sensors may be at the storage input stations 430, the storage input/output stations 430/440, and/or the storage output stations 440. For example, a carrier detection sensor may be provided on each carrier stool provided in the classified lock storage system 400, where each carrier detection sensor is configured to indicate, to the control monitoring module 454, when the presence of a universal lock carrier is detected on the carrier stool. The carrier detection sensors may comprise pressure switches, proximity sensors (such as that use an electromagnetic field or electromagnetic radiation), barcode scanners, or RFID readers, for example. Carrier detection sensors may also be located at any suitable location in the classified lock storage system 400, for instance at certain locations along the operational route of the classified lock transportation system 420.

The controller 450 may also comprise a carrier identification module 455 configured to identify universal lock carriers within the classified lock storage system 400. For instance, the carrier identification module 455 may use information supplied by the one or more sensors of the classified lock storage system 400 to identify a particular universal lock carrier being used in the classified lock storage system 400. For example, the identification of a particular universal lock carrier may be in response to RFID or barcode readings communicated from any location in the classified lock storage system 400. The identification of a particular universal lock carrier may be performed by comparing the supplied information with a list of unique identifiers, each of which is linked to only one universal lock carrier. The carrier identification module 455 may make the identifications available to the other modules. For instance, in some examples, the inventory management module 453 may use the identifications to maintain records of associations between a universal lock carrier and a classification of a twist-lock loaded on the universal lock carrier and between a storage location of the classified lock storage system and the universal lock carrier. Similarly, the carrier monitoring module 454 may use the identifications to keep track of the specific location of universal lock carriers across the classified lock storage system 400. For example, the carrier monitoring module 454 may determine or confirm an expectation, based on information supplied by the one or more sensors, that a uniquely identified universal lock carrier has been transported to the classified lock store and is now ready to be stored in one of the storage locations.

The controller 450 may comprise a storage module 458, for instance to store machine readable instructions that are executable by the processing circuitry and/or store data usable by the controller. For example, data relating to the inventory of classified twist-locks may be stored on the storage module 458. For instance, a database that contains the records of associations between a universal lock carrier and a classification of a twist-lock loaded on the universal lock carrier and between a storage location of the classified lock storage system and the universal lock carrier may be stored on the storage module 458. The inventory management module 453 can interrogate the storage module 458 to obtain records data regarding the storage locations of universal lock carriers having an association with a particular classification of twist-lock.

The controller 450 may comprise a communications interface 459 to communicatively couple the controller 450 to the rest of the classified lock storage system 300. Furthermore, the communications interface 459 may communicatively couple the controller 450 to other systems as described herein. For instance, the communications interface 459 may communicatively couple the controller 450 to the classification controller 380, which, for example, permit coordination between the lock storage controller 450 and the classification controller 380 over the management of common carrier stools 600 and associated sensors. Similarly, the communications interface 459 may communicatively couple the controller 450 to the one or more pinning station controllers 230, which, for example, permit coordination between the lock storage controller 450 and the one or more pinning station controllers 230 over the management of common carrier stools 600 and associated sensors.

Various examples of carrier stools and universal lock carriers will now be described in more detail with reference to FIGS. 21 to 26. The carrier stools described herein provide a working position permitting the exchange of twist-locks between the various segments of the container lock management system 100.

FIG. 21 illustrates one example of a carrier stool 600. The carrier stool 600 comprises a pedestal 610, or stand, and one or more seats 620. The pedestal 610 supports the one or more seats 620. Each seat 620 is configured to removably receive and support a universal lock carrier 700. The universal lock carrier 700 may be loaded with a twist-lock 50.

In the example of FIG. 21, the pedestal 610 supports three seats 620. It will be understood that the pedestal 610 may support any suitable number of seats 620 according to operational requirements. For instance, the carrier stool 600 may comprise one seat 620 or a plurality of seats 620. It will also be understood that the pedestal 610 may comprise an individual structural support for each corresponding seat 620 or a single structural support that supports all the seats 620 of the carrier stool 600. For instance, independent structural supports for each corresponding seat 620 may be joined to one another for additional strength or completely independent.

Each seat 620 comprises one or more positioning elements 622 configured so that the universal lock carrier 700 is repeatably (and removably) receivable on the seat 620 in the same position each time relative to the seat 620 and/or carrier stool 600. Since the universal lock carrier 700 is interchangeable with other universal lock carriers 700, as described further below, the positioning elements 622 allow the position of any of the interchangeable universal lock carriers 700, relative to the seat 620 and/or carrier stool 600, to be reliably known once the universal lock carrier 700 is supported on the seat 620.

In one example, such as that shown in FIG. 21, the one or more positioning elements 622 comprises at least one alignment pin 624 onto which the universal lock carrier 700 is mountable. In the example shown in FIG. 21, the at least one alignment pin 624 constrains the position of the universal lock carrier 700 in an X-Y plane and allows the universal lock carrier 700 to move linearly in a Z-direction. In certain examples, the at least one alignment pin 624 may have a circular profile, i.e., be a round pin. In other examples, the at least one alignment pin 624 may have a flattened diamond profile or other suitable polygonal-shaped profile. Using a polygonal shape for the pin profile can improve the positional accuracy of the universal lock carrier 700 in the X-Y plane. The alignment pin 624 may be tapered and/or have a spherical end. In certain examples, the one or more positioning elements 622 comprises two or more alignment pins 624. Using two or more alignment pins 624 can improve the positional accuracy of the mounted universal lock carrier 700 in the X-Y plane. The two or more alignment pins 624 may have the same profile or different profiles. For example, one alignment pin 624 may comprise a circular profile and another alignment pin 624 may comprise a polygonal shaped a flattened diamond profile. Each of the two or more alignment pins 624 may have a different length or height from the other alignment pins of the two or more alignment pins 624. Providing differing lengths of alignment pin may permit an initial coarse alignment followed by a finer alignment of the universal lock carrier 700 as the universal lock carrier 700 is loaded on the seat 620.

As also shown in FIG. 21, the one or more positioning elements 622 may comprise a stop 626 to position the universal lock carrier 700 in the Z-direction. The universal lock carrier 700 rests on the stop 626 when supported on the seat 620. In the example shown in FIG. 13, the stop comprises a flat ended pin, which is separate from the alignment pins 624. The flat ended pin has a flat surface that is arranged substantially perpendicular to the Z-direction. In other examples, the stop may comprise a shoulder pin or ball end pin. For example, one or more of the alignment pins 624 may comprise a shoulder on which the universal lock carrier 700 rests when supported on the seat 620. The shoulder is arranged substantially perpendicular to the Z-direction.

The carrier stool 600 may comprise one or more sensors 630 configured to monitor the status of the carrier stool 600 with respect to universal lock carriers 700. The one or more sensors 630 may be communicatively coupled to one or more controllers as described herein. The one or more sensors may be configured to detect the presence and/or absence of a universal lock carrier 700 supported on the seat 620, for instance. The one or more sensors 630 may be configured to detect the presence and/or absence of a twist-lock loaded on a universal lock carrier 700 when the universal lock carrier 700 is supported on the seat 620, for instance.

The carrier stool 600 may comprise one or more identification (ID) readers 640. The one or more ID readers 640 may be configured to obtain data from a unique identifier linked only with a particular universal lock carrier 700. The data may be used, for instance by a controller as described herein, to identify, or confirm the identity, of the particular universal lock carrier 700. Using the data may permit the updating, or validating, of an inventory of twist-locks and/or universal lock carriers 700 as described hereinabove. For instance, the one or more ID readers 640 may each comprise a RFID reader configured to read a RFID tag associated with a particular universal lock carrier 700. Other identification systems could equally be used, for instance the one or more ID readers 640 may each comprise an optical label reader.

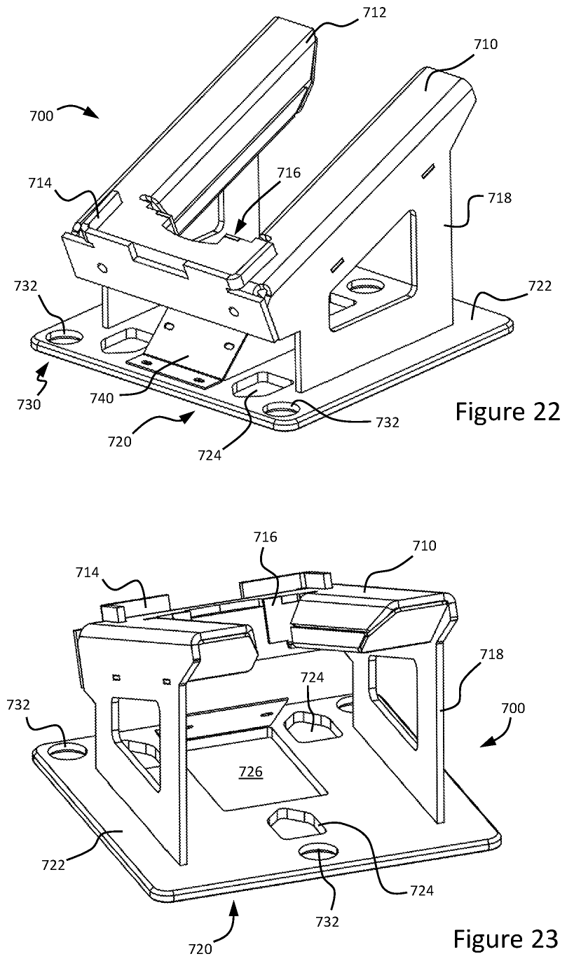

FIGS. 22 and 23 show perspective views of an example of a universal lock carrier 700. The universal lock carrier 700 comprises a cradle 710 that is configured to releasably receive and support a twist-lock loaded on the universal lock carrier 700. The cradle 710 may be configured to receive and support any suitable number of different types and models of twist-lock. The universal lock carrier 700 comprises a storage system interface 720. The storage system interface 720 permits the handling of the universal lock carrier 700 by, and within, a classified lock storage system as described herein. The storage system interface 720 is configured so that the universal lock carrier 700 can be gripped, moved, picked up and handled by the classified lock storage system. In certain examples, the storage system interface 720 is configured to be complementary to, and engage with, a carrier interface of classified lock storage system as described above.

The cradle 710 may comprise one or more guides 712 that facilitate the positioning of a twist-lock on the cradle 710. The cradle 710 may comprise one or more location elements 714 that ensure that a twist-lock is located in the correct position once on the cradle 710. The cradle 710 may also comprise one or more contact elements 716. The contact elements 716 may assist with ensuring that a twist-lock is located in the correct position once in the cradle 710. The contact elements 716 may comprise a suitable material that is durable to withstand repeated mechanical contact with twist-locks and be resistant to friction-related wear. For instance, the contact elements 716 may comprise hardened steel. The contact elements 716 may be configured to accommodate the majority of the contact forces involved in loading and unloading a twist-lock on the universal lock carrier 700.

In the example shown in FIGS. 22 and 23, the cradle 710 comprises a U-shaped support for a twist-lock. The U-shaped support of the cradle 710 is set at an angle to the horizonal, which can allow the lock manipulators described herein to access the cradle 710 more efficiently. The U-shaped support is held in place by a pair of uprights 718. The uprights 718 are arranged substantially parallel to one another and are spaced apart. This arrangement permits access to the twist-lock from beneath the universal lock carrier 700, for instance so that sensors on the carrier stool 600 can monitor the status of the universal lock carrier 700.

The storage system interface 720 acts to support the cradle 710. In the example shown in FIGS. 22 and 23, the uprights 718 are mounted to the storage system interface 720. The storage system interface 720 comprises a base plate 722, which is substantially rectangular in this example. It will be understood that the storage system interface 720 may be arranged in any suitable manner that allows the universal lock carrier 700 to be handled by the classified lock storage system. In this example, the storage system interface 720 comprises three orientation slots 724 in the base plate 722. The orientation slots 724 are arranged in a substantially triangular configuration. Each of the orientation slots 724 is configured to engage with a corresponding orientation protrusion 4286 of the carrier interface 4284 of the classified lock transportation system 400 as described above. The orientation slots 724 help to ensure that the universal lock carrier 700 is located correctly on the carrier interface 4284 so that the universal lock carrier 700 can be reliably positioned on a carrier stool 600 or in a storage berth 412. In this example, the storage system interface 720 comprises a cut out 726 in the base plate 722. The cut out 726 permit access to the twist-lock from beneath the universal lock carrier 700, for instance for sensors on the carrier stool 600 as mentioned above.

The cradle 710 may comprise one or more complementary positioning elements 730. The complementary positioning elements 730 are configured to cooperate with the positioning elements 622 as the universal lock carrier 700 is received on the carrier stool 600. In the example shown in FIGS. 22 and 23, the complementary positioning elements 730 comprises one or more alignment pin receptacles 732, in this case round holes, although any complementary shape may be employed. In examples where the positioning elements 622 comprise alignment shoulder pins, the base plate 722 may engage with the shoulder to prevent movement in the Z-direction of the carrier stool 600 as described above.

In certain examples, the universal lock carrier 700 may comprise a unique identifier that allows the universal lock carrier 700 to be identified, or have an identity validated. For example, the universal lock carrier 700 may comprise a RFID tag that is readable by a RFID reader, for instance an RFID reader of the carrier stool 600. In other examples, the unique identifier may comprise a machine-readable optical label such as a barcode. The universal lock carrier 700 of FIGS. 22 and 23 comprises a unique identifier support 740 to which an RFID tag or barcode or the like is mountable. The unique identifier support 740 comprises a plate fixed to the base plate 722.

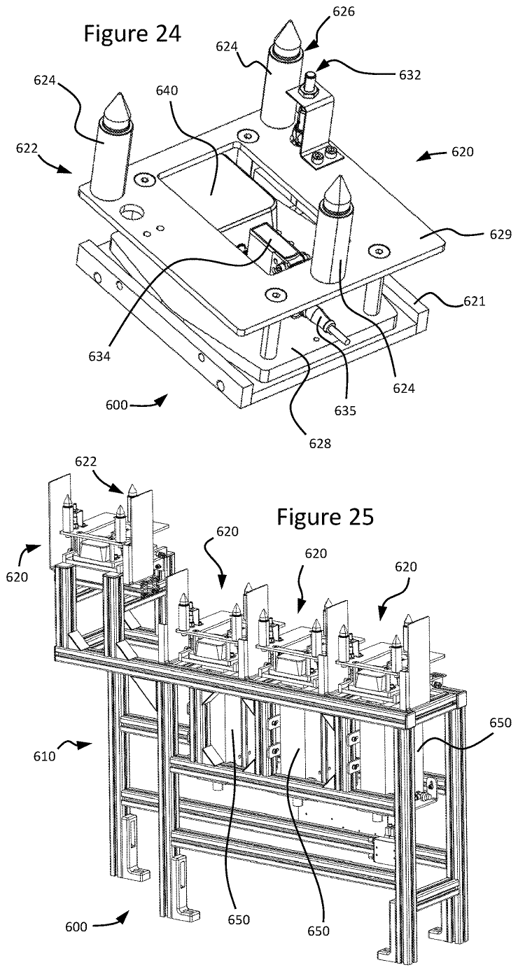

Turning now to FIG. 24, which shows a perspective view of another example of a carrier stool 600. The carrier stool 600 is compatible with the example universal lock carrier 700 illustrated in FIGS. 22 and 23. For the sake of clarity, the carrier stool 600 in FIG. 24 illustrates the seat 620 without the supporting pedestal. In this example, the positioning elements 622 of the seat 620 comprises three elongate alignment pins 524 arranged in a substantially triangular formation. The alignment pins 624 are shoulder pins in which each comprise a shoulder that forms a stop 626 to prevent movement of the universal lock carrier 700 in the longitudinal direction of the alignment pins 624. The universal lock carrier 700 rests on the shoulders of the alignment pins 624 when supported on the seat 620.

The seat 620 comprises a calibration element 628 that supports the positioning elements 622. The calibration element 628 is configured to allow adjustment of the positioning elements 622 so that the positioning elements 622 can be aligned in the desired manner with the elements of the container lock management system 100 that will function together with the carrier stool 600, for example the lock manipulators, machine vision systems, and classified lock transportation system as described herein. The calibration element 628 provides a certain tolerance in positioning the carrier stool 600 for use in the container lock management system 100. In the example shown in FIG. 24, the calibration element 628 comprises a plate rotatably mounted on a frame 621 of the seat 620. The frame 621 connects the seat 620 to the pedestal. The plate is shaped to permit a certain range of rotation before colliding with the frame 621; in this way, the plate is free to rotate enough to allow the positioning elements 622 to be aligned as desired. In the example shown in FIG. 24, the calibration element 620 also supports an alignment pin plate 629 to which the alignment pins 624 are mounted. The alignment pin plate 629 is offset from the calibration element 628 plate to accommodate sensors and the like.

The carrier stool 600 comprises a carrier detector 632 and a lock detector 634. In the example shown in FIG. 24, the carrier detector 632 and the lock detector 634 are mounted to the seat 620. The carrier detector 632 is to determine whether a universal lock carrier 700 is present on the seat 620. In this example, the carrier detector 632 comprises an inductive proximity sensor; however, other suitable sensors may be used, for example a pressure activated proximity switch. The lock detector 634 is to determine whether a twist-lock is present on the universal lock carrier 700 when located on the seat 620. In this example, the lock detector 634 comprises a photoelectric sensor. The carrier stool 600 comprises a RFID reader 640. The RFID reader 640 is to read an RFID tag associated with, or affixed to, the universal lock carrier 700. The lock detector 634 is communicatively coupled to one or more controllers, such as any of the controller described herein, via a communication cable 635. Although not illustrated, the carrier detector 632 and the RFID reader 640 are also communicatively coupled to the one or more controllers via communication cables thereby permitting data concerning the status of the carrier stool 600 to be transmitted to the one or more controllers.

FIG. 25 shows a perspective view of another example of a carrier stool 600 that is compatible with the example universal lock carrier 700 illustrated in FIGS. 22 and 23. In this example, at least one of the seats 620 is moveable, for instance relative to the pedestal 610, so that the position of the universal lock carrier 700 may be adjusted. For instance, at least one of the seats 620 may be moveable in a vertical direction. In the example of FIG. 25, the pedestal 610 of the carrier stool 600 supports four seats 620. Each of the seats 620 is substantially arranged in the same manner as that described with respect to FIG. 24, although other arrangements may be deployed. One of the seats 620, located at one end of the pedestal 610 is fixed in position. The remaining three seats 620 are moveable in a vertical direction so that the vertical position of the universal lock carrier 700 may be adjusted. Providing some seats 620 that are moveable in this manner allows flexibility in a working position for the lock manipulators described herein when manipulating twist-locks on and off universal lock carriers 700. Furthermore, in some examples, the lock manipulators described herein may operate at a different working position from the classified lock transportation system described herein.

The carrier stool 600 shown in FIG. 25 may be particularly useful when implemented as a twist-lock storage input/output station for a container pinning station as described herein. Providing some seats 620 that are moveable in this manner also provides for allowing a universal lock carrier 700 to be lifted off a carrier interface of a lock transportation system of a classified lock storage system.

The carrier stool 600 of FIG. 25 comprises one or more elevators 650 that are each configured to move one of the seats 620 up and down in the vertical direction. Each elevator comprises, for example, a pneumatic actuator to drive the corresponding seat 620 up and down. Another motive source may instead be used, such as an electrically powered ball screw, for example.

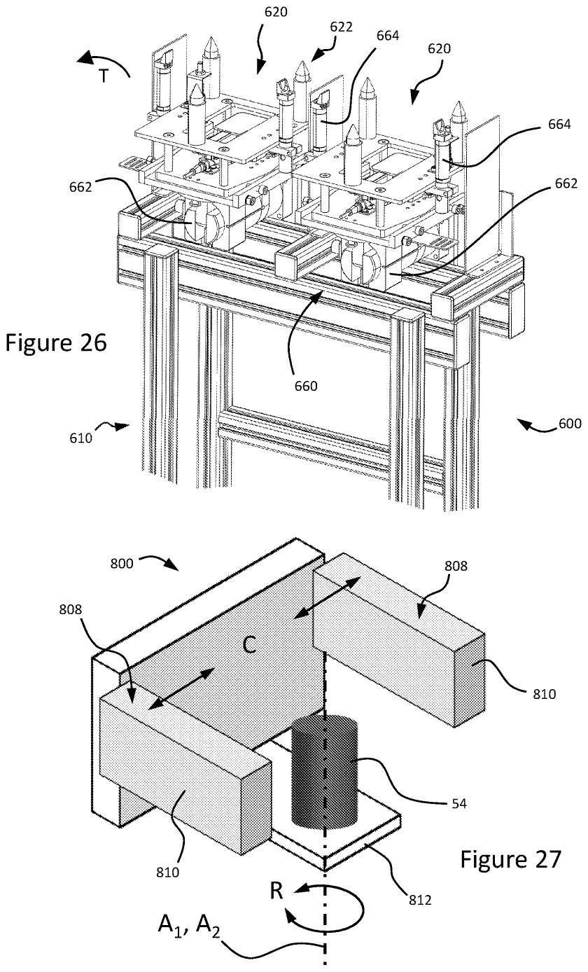

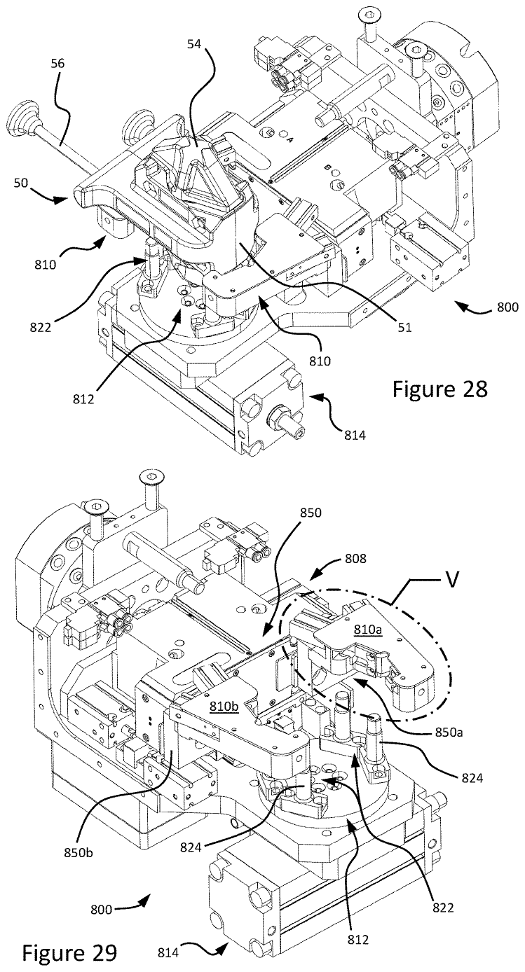

FIG. 26 shows a perspective view of another example of a carrier stool 600 that is compatible with the example universal lock carrier 700 illustrated in FIGS. 22 and 23. In this example, at least one of the seats 620 is tiltable so that, in use, a twist-lock, loaded on a universal lock carrier, is unloadable from the universal carrier. In the example of FIG. 26, the pedestal 610 of the carrier stool 600 supports two seats 620. Each of the seats 620 is substantially arranged in the same manner as that described with respect to FIG. 24, although other arrangements may be deployed. The two seats are tiltable in the direction of arrow T so that a twist-lock, loaded on a universal lock carrier 700, may be unloaded from the universal carrier 700. Thus, the carrier stool 600 of FIG. 26 may be used to empty universal lock carriers 700 of twist-locks. In this regard, the carrier stool 600 of FIG. 26 may be used as a storage output station of a classified lock storage system as described herein. For instance, the carrier stool 600 of FIG. 26 may be a carrier emptying station as described herein where classified twist-locks are unloadable from universal lock carriers 700.

To effect emptying of a universal lock carrier 700, the carrier stool 600 of FIG. 26 comprises a tilt mechanism 660 that, in use, rotates, or tilts, the seat 620 upwards about a suitably arranged axis. As can be seen from FIGS. 22 and 23, the universal lock carrier 700 supports twist-locks on the U-shaped support. In combination with the seated orientation of the universal lock carrier 700 on the seat 620, the tilting motion T is arranged such that as the universal lock carrier is rotated, a supported twist-lock will slide off the U-shaped support under gravity and be unloaded from the universal lock carrier 700. The unloaded twist-lock may drop into a lock bin as described herein.

In the example shown in FIG. 26, the tilt mechanism 660 comprises an actuator 662, such as a rotational pneumatic actuator, although the actuator 662 may comprise an electrically powered rotational actuator or other suitable motive source. The tilt mechanism 660 may also comprise a latch 664 configured to hold the universal lock carrier 700 on the seat 620 during the tilting motion thereby preventing the universal lock carrier 700 from falling from the seat 620. The latch 664 may comprise a releasable catch that grips the universal lock carrier 700, for instance on the base plate 622. The releasable catch may comprise a retractable or rotatable portion that grips the universal lock carrier 700.

Certain examples of a pinning gripper will now be described. With reference to FIGS. 2 and 29 to 38 of the drawings, a container twist-lock pinning/unpinning assembly, in the form of a pinning gripper is indicated generally with the reference numeral 800. The pinning gripper 800 is configured for rotatably displacing a cam 54 of a twist-lock 50 between a locking condition in which the cam 54 of the twist-lock 50 engages a corner block 12 of an intermodal container to which the twist-lock 50 is fitted, for locking the twist-lock 50 to the corner block 12, and an unlocking condition in which the cam 54 is disengaged from the corner block 12, thereby permitting both insertion and withdrawal of the cam 54 from the corner block 12, during fitting and removal of the twist-lock 50 to and from the corner block 12, respectively.

The pinning gripper 800 includes a twist-lock body gripping attachment 808 for gripping a supporting body 51 of a twist-lock 50, a cam actuating mechanism 812 for gripping the cam 54, a rotary actuator 814 for rotating the cam actuating mechanism 812, displacing means in the form of a displacing system for displacing moving parts of the pinning gripper 800, as will be explained in more detail hereinbelow and an electronic control module for controlling operations as will be explained hereinbelow.

The twist-lock body gripping attachment 808 includes a pair of opposable jaw members 810 comprising jaw members 810a and 810b which are movable relative to one another and configured, in use, to grip a supporting body 51 of a twist-lock 50. More specifically, the jaw members 810 are configured to controllably engage and grip the supporting body 51 in a predetermined configuration, as required and determined by the size and shape of the particular twist-lock 50 and twist-lock body 51, and by a location and orientation of an axis (A1) of rotation of the cam 54 relative to the twist-lock body 50, to optimally orientate and locate the axis of rotation (A1) of the cam 54 of the twist-lock 50 with respect to an axis (A2) of rotation of the rotary actuator 814. The axis of rotation (A1) of the cam 54 of the twist-lock 50 is substantially perpendicular to a plane in which the jaw members 810a1 and 810b2 move, in use.

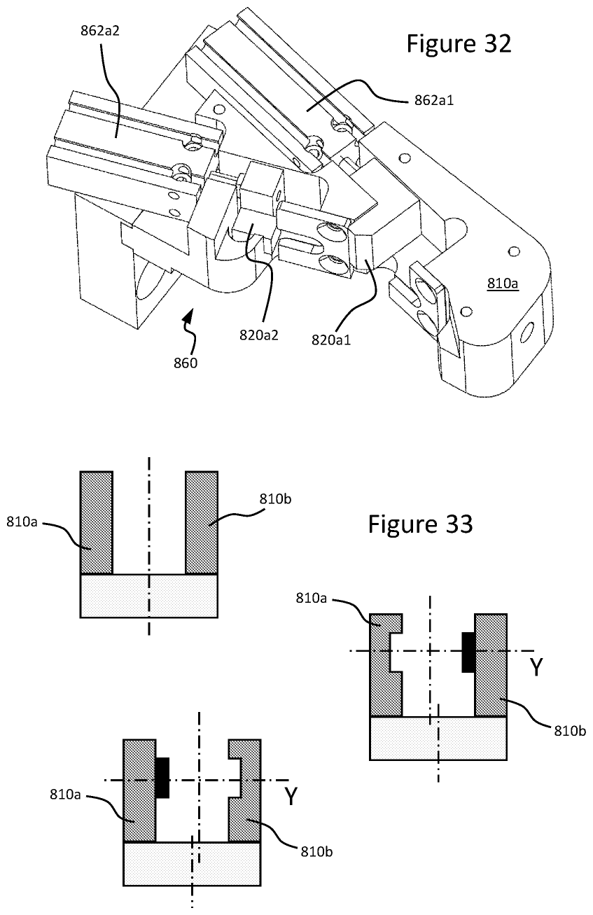

As best illustrated in FIGS. 31 and 32, each one 810a, 810b of the opposable jaw members 810 is provided with controllable movable portions, in the form of fingers 820, comprising movable fingers 820a1, 820a2 on jaw member 810a and movable fingers 820b1, 820b2 on the other jaw member 810b, the fingers 820 each being movable with respect to an associated one of the jaw members 810a, 810b, as will be explained below. More specifically, the fingers 820 are independently movable relative to one another, as will be explained in more detail below.

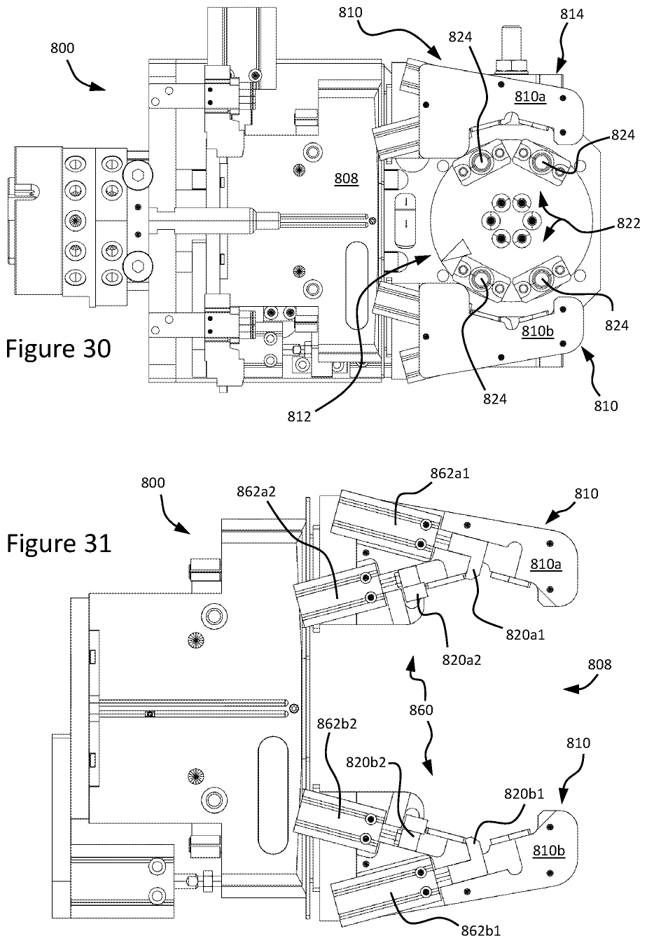

The cam actuating mechanism 812 is configured, in use, for actuating the cam of the twist-lock and includes a cam gripping attachment 822 for gripping the cam 54 of the twist-lock 50 and for displacing the cam 54 of the twist-lock 50 relative to the supporting body 51 of the twist-lock 50, as will be explained below. With reference to FIGS. 29 and 30, the cam actuating mechanism 812 includes four upstanding pin members 824 for engaging the cam 54 of the twist-lock 50. The size of the pin members 824 and the location thereof are selected such that twist lock cams of various sizes can be seated in the cam actuating mechanism 812. In other embodiments (not shown), the Applicant envisages that the location and/or size of the pin members 824 may be variable and/or controllable, so as to adjust a size and/or location of the pin members 824 according to the dimensions of the cam of the twist lock received therein.

The rotary actuator 814 is configured for rotating the cam actuating mechanism 812 about the axis (A2) of rotation of the rotary actuator 814 for displacing the cam 54 of the twist-lock 50 between the locking condition and the unlocking condition, during pinning and unpinning operations, thereby permitting said fitting or removal of the twist-lock 50 to and from the corner block 12.

The displacing system is configured for displacing moving parts of the pinning gripper 800, and includes the twist-lock body gripping attachment displacing system, the jaw members displacing system, and the movable fingers displacing system.

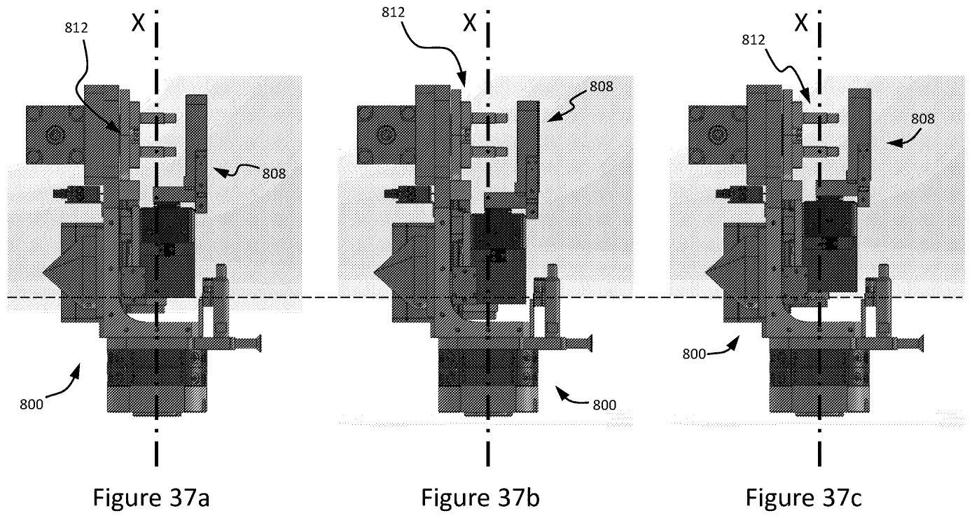

Operation of the twist-lock body gripping attachment displacing system is shown in FIGS. 37a, 37b and 37c. With reference to these figures, it can be seen that the twist-lock body gripping attachment displacing system is operable to displace the twist-lock body gripping attachment 808 relative to the cam actuating mechanism 812 in three stages corresponding with the three positions shown in FIGS. 37a, 37b and 37c. As can be seen from the drawings, the twist-lock body gripping attachment displacing system provides for translational movement of the twist-lock body gripping attachment 808 relative to the cam actuating mechanism 812.

With reference to FIG. 38 of the drawings, the twist-lock body gripping attachment displacing system comprises pneumatic piston/cylinder mechanisms 836 and 838, base plate 840, locking pin assembly 842 and latching cylinder 844.

The pneumatic piston/cylinder mechanisms 836 and 838 comprise two opposing mechanisms which work against one another for displacing the twist-lock body gripping attachment 808 in opposite directions. By controlling the relative force exerted by the pneumatic piston/cylinder mechanisms 836 and 838, the position of the twist-lock body gripping attachment can be regulated for displacing the twist-lock body gripping attachment between the three positions illustrated in FIGS. 37a, 37b and 37c, respectively.

To enhance the stability and precision of the displacing system, the base plate 840 and locking pin assembly 842 are provided. More specifically, the base plate 840 includes three slots 846a, 846b and 846c, which extend to an edge of the plate 840. In use, when the base plate 840 is displaced (by the pneumatic piston/cylinder mechanisms 836 and 838) into position, a locking pin of the locking pin assembly 842 is deployed and displaced into a locking position in which the locking pin is received in a particular one of the slots 846a, 846b, 846c for stabilizing the assembly when the pneumatic piston/cylinder mechanisms 836 and 838 displace the twist-lock body gripping attachment 808 into the positions shown in FIGS. 37a, 37b and 37c.

The latching cylinder 844 is operable to displace the locking pin between the locking position, in which the pin locks the base plate 840 in position, and an unlocking position, in which the pin is displaced away from the three slots 846a, 846b and 846c, thereby permitting displacing of the base plate 840.

Referring now to FIG. 29 of the drawings, the jaw members displacing system is operable to displace the opposable jaw members 810 relative to one another and for displacing the fingers 820 relative to one another. The jaw member displacing system includes jaw member displacing piston-cylinder mechanism 850, including piston-cylinder mechanisms 850a, 850b for respectively and independently displacing the opposable jaw members 810a, 810b respectively relative to one another.

Referring to FIG. 31, the movable finger displacing system includes finger displacing piston-cylinder mechanisms 860, including piston-cylinder mechanisms 862a1, 862a2, 862b1 and 862b2 for displacing the associated one of the fingers 820a1, 820a2, 820b1 and 820b2 as illustrated in FIG. 31 of the drawings.

More specifically, as illustrated in FIGS. 36a through to 36d, the fingers 820 can each be displaced between fully retracted positions and fully extended positions.

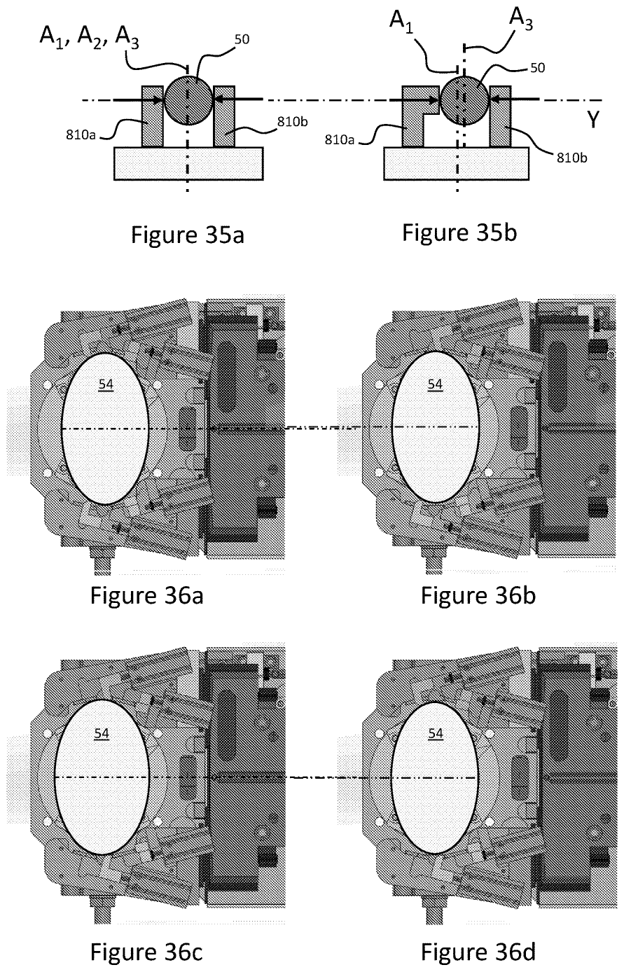

Referring to FIGS. 35a and 35b, advantageously, the finger displacing piston-cylinder mechanisms 860 are capable of changing the symmetry of the opposable jaw members 810 from a symmetric configuration shown in FIG. 35a to an asymmetric configuration shown in FIG. 35b.

More specifically, when in the symmetric configuration as shown in FIG. 35a of the drawings, the fingers are retracted and a central axis (A3) of a twist-lock gripped in the opposable jaw members 810 is aligned precisely with the axis (A1) of rotation of the cam 54 and with the axis (A2) of rotation of the rotary actuator.

When in the asymmetric configuration shown in FIG. 35b of the drawings, a central axis (A3) of a twist-lock gripped in the opposable jaw members 810, is offset relative to the axis (A1) of rotation of the cam 54, as shown in FIG. 35b. The purpose and significance of this will be explained below.

The electronic control module may form a part of the manipulator module 234 of the pinning station controller 230 described above. In other examples, the electronic control module may instead be a module of a separate controller. The electronic control module is configured for controlling operation of the pneumatic piston/cylinder mechanisms 836, 838, the latching cylinder 844, the jaw member displacing piston-cylinder mechanisms 850a, 850b of the jaw member displacing system, and the finger displacing piston-cylinder mechanisms 862a1, 862a2, 862b1 and 862b2. It will be understood that the electronic control module may be configured for controlling other operations and/or pneumatic piston/cylinder mechanisms.

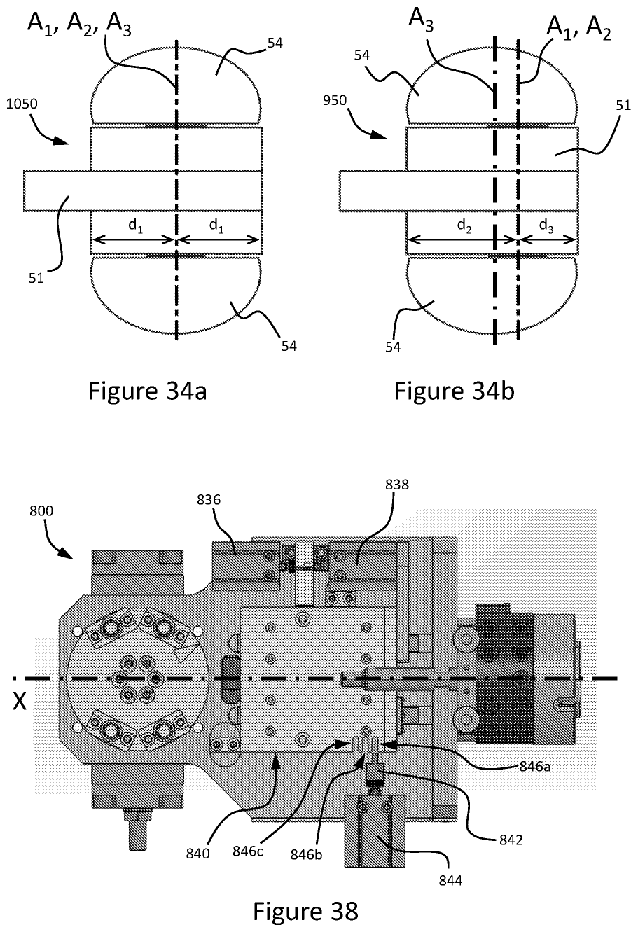

In use, the electronic control module is operable to displace each one of the jaw members 810a, 810b, relative to one another to effectively accommodate and grip twist-lock bodies of different shapes and sizes as illustrated in FIGS. 34a and 34b. More specifically, as illustrated in FIGS. 34a and 34b, the electronic control module is operable to independently control the fingers 820a1, 820a2, 820b1 and 820b2 so as to controllably accommodate twist-lock supporting bodies 51 of different sizes.

More specifically, in use, the displacing system is operable for displacing a twist-lock 50 which is gripped by the pair of jaw members 810a, 810b, in use, along a set of x and y, axes which are perpendicular with respect to one another, in a: forward, backward, left and right direction, from a point of view of an observer observing from a top-view. More specifically, with reference to the top view shown in FIG. 38 of the drawings and the side view shown in FIG. 37 of the drawings, the piston-cylinder mechanisms 836 and 838 of the displacing system are operable for displacing a twist lock 50 gripped in the grippers in a forward and backwards direction, along axis “x” shown in FIGS. 37 and 38 of the drawings.

With reference to the top views shown in FIGS. 33 and 35a and 35b of the drawings, the piston-cylinder mechanisms 850a, 850b of the displacing system are operable for displacing a twist lock 50 gripped in the grippers 810a, 810b in a left and right direction, along axis “y” shown in FIGS. 33, 35a and 35b of the drawings.

As such, the container pinning gripper 800 is operable, by operation of the displacement means, to displace a twist-lock 50 which is gripped by the pair of jaw members 810a, 810b, such that an axis (A1) of rotation of the cam 54 of the twist-lock 50 is displaced with respect to the axis (A2) of rotation of the rotary actuator 814.

More specifically, the pinning gripper 800 is operable, by operation of the displacement means, to displace a twist-lock 50 which is gripped by the pair of jaw members 810a, 810b, such that an axis (A1) of rotation of the cam 54 of the twist-lock 50 is co-axially aligned with respect to the axis (A2) of rotation of the rotary actuator 814.

The pinning gripper 800 is therefore operable to align a twist-lock 50 such that an axis (A1) of rotation of the cam 54 of the twist-lock 50 is co-axially aligned with respect to the axis (A2) of rotation of the rotary actuator 814.

This above described feature is important since while some twist-locks, such as twist-lock 1050 shown in FIG. 34a of the drawings have a central axis (A3) of the twist-lock 1050 which is aligned with the axis (A1) of rotation of the cam 54 of the twist-lock 1050, other twist-locks, such as, for example, twist-lock 950 shown in FIG. 34b of the drawings, have an axis (A1) of rotation which is offset with respect to a central axis (A3) of the twist-lock 950.

If required for proper operation of the twist-lock 50, the container pinning gripper 800 is operable, by operation of the displacement system described herein above, to displace a twist-lock 50 which is gripped by the pair of jaw members 810a, 810b such that the axis of rotation (A2) of the rotary actuator 814 is co-axially aligned with the axis of rotation (A1) of the cam 54 of the twist-lock 50 and at the same time, offset with respect to the central axis (A3) of the cam 54 of the twist-lock. This is extremely important to enable the pinning gripper 800 to lock and unlock twist locks, such as twist lock 950, shown in FIG. 34b, in which the axis (A1) of rotation of the cam 54 of the twist-lock 950 is offset from the central axis (A3) of the cam 54 of the twist-lock 950. As shown in FIG. 34b, the displacement system is able to grip and orientate the twist-lock 950 so that the axis (A1) of rotation of the cam 54 of the twist-lock 950 is perfectly aligned with the axis of rotation (A2) of the rotary actuator, to permit the locking and unlocking of the twist lock 950.

The Applicant has found that the above-described adjustability enables the pinning gripper 800 to handle a wide variety of differently shaped and configured twist-locks, particularly, twist-locks in which the axis of rotation of the cam of the twist-lock is substantially offset from a central axis of the body of the twist-lock.

Advantageously, by: controllably displacing the twist-lock body gripping attachment 808 relative to the cam actuating mechanism 812, by means of the twist-lock body gripping attachment displacing system, as shown in FIGS. 37a, 37b and 37c; and controllably displacing the opposable jaw members 810a, 810b and the movable fingers thereof, as described hereinabove, the pinning gripper 800 is operable to displace the axis of rotation of the cam of a twist-lock which is gripped by the pair of jaw members, relative to the axis of rotation of the rotary actuator for aligning these axes of rotation, to permit locking and unlocking of twist-locks from the corner blocks. As such, the pinning gripper 800 can handle a wide variety of twist-locks in which the axis of rotation is offset from a central axis.

Furthermore, the Applicant has found that the pinning gripper 800 is particularly advantageous because by securely gripping the body of the twist-lock 50 in the jaw members 810, the pinning gripper 800 requires no manual intervention as the pinning gripper 800 is able to pick up, and fit a multitude of different types of twist-locks to corner blocks of intermodal containers. More specifically, the pinning gripper 800 is configured to pick up a twist lock from the universal lock carrier 700 and to be moved to a suitable position for fixing to a corner block 12. This is done entirely without human intervention.

Due to the configuration described above, the pinning gripper 800 is able to securely grip the body of the twist-lock 50 in the opposable jaw members 810a, 810b and unlock (remove) the twist-lock 50 from a corner block 12. The pinning gripper 800 is able to securely grip the body of the twist-lock 50 in the opposable jaw members 810a, 810b and fix the twist-lock 50 to a corner block 12. Once a twist-lock 50 is unlocked from a corner block 12, the jaw members 810a, 810b have a sufficient grip on the body of the twist-lock 50 remove the twist-lock from the corner block 12 and place the twist-lock 50 into receptacles, for storage and processing, as described and defined elsewhere herein. For instance, using the pinning gripper 800, the unlocked twist-lock 50 may be placed into a universal lock carrier 700 as described herein above. Conversely, using the pinning gripper 800, the twist-lock 50 may be retrieved for pinning operations from a universal lock carrier 700 as described herein above.

It will be understood that the above embodiment descriptions are given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the scope of this invention. It is to be understood that any feature described in relation to one example may be used alone, or in combination with other features described, and may also be used in combination with any features of any other of the examples, or any combination of any other examples.

1. A classified lock storage system for container twist-locks, the classified lock storage system configured to store a plurality of classified twist-locks in an organised and traceable manner, the classified lock storage system comprising:
a classified lock store having a capacity to store the plurality of classified twist-locks, wherein the classified lock store comprises a plurality of storage locations each of which configured to temporarily store one classified twist-lock from the plurality of classified twist-locks;
one or more storage input stations through which twist-locks can be put into the classified lock storage system;
one or more storage output stations through which twist-locks can be removed from the classified lock storage system; and
a classified lock transportation system usable to move twist-locks around the classified lock storage system.

2. The classified lock storage system of claim 1, wherein the classified lock storage system is configured to maintain an inventory of stored classified twist-locks according to the classification of twist-lock stored in each storage location.

3. The classified lock storage system of claim 1, wherein the classified lock storage system is configured to maintain a record of the type and/or model of twist-lock stored in a particular storage location.

4. The classified lock storage system of claim 1, classified lock transportation system is configured to, in use, receive classified twist-locks from the one or more storage input stations and deliver the classified twist-locks to the classified lock store for storage in one of the storage locations and/or is configured to, in use, retrieve classified twist-locks from the classified lock store and to deposit the classified twist-locks at the one or more storage output stations.

5. The classified lock storage system of claim 4, wherein classified twist-locks are receivable at one of the one or more storage input stations from a corresponding lock classification system and/or at one of the one or more storage input stations from a container pinning system.

6. The classified lock storage system of claim 4, wherein retrieved classified twist-locks are depositable at one or more storage output stations for use in a corresponding container pinning system.

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. A container lock management system comprising:
one or more container pinning systems; and
the classified lock storage system according to claim 1.

23. The container lock management system of claim 22, wherein the container lock management system comprises a lock classification system.

24. The container lock management system of claim 22, wherein the container lock management system comprises one or more universal lock carriers.

25. A method for managing a twist-lock in a classified lock storage system, the method comprising:
retrieving, from an input station, a universal lock carrier loaded with a classified twist-lock;
transporting the universal lock carrier to a classified lock store;
identifying a free storage location in the classified lock store and assigning the storage location to the universal lock carrier; and
placing the universal lock carrier in the storage location.

26. The method of claim 25, wherein retrieving the universal lock carrier loaded with the classified twist-lock comprises retrieving the universal lock carrier from a container pinning system or a lock classification system.

27. The method of claim 25, wherein the method comprises generating data representing an association between the universal lock carrier and a classification of the twist-lock, wherein the data is generated based on, or from, data representing an association between the classification and the twist-lock loaded on the universal lock carrier.

28. The method of claim 27, wherein the data is generated based on a unique identifier linked with the universal lock carrier.

29. The method of claim 27, wherein the method comprises recording the data representing an association between the universal lock carrier and a classification of the twist-lock in an inventory database.

30. The method of claim 27, wherein the method comprises generating data representing an association between the storage location and the universal lock carrier placed therein.

31. The method of claim 30, wherein the method comprises recording the data representing the association between the storage location and the universal lock carrier in the inventory database.

32. A method for managing a twist-lock in a classified lock storage system, the method comprising:
retrieving, using data representing an association between a storage location and a universal lock carrier placed therein and data representing an association between the universal lock carrier and a classification of a twist-lock, the universal lock carrier from the storage location;
transporting the universal lock carrier to an output station; and
depositing the twist-lock loaded on the universal lock carrier at the output station.

33. The method of claim 32, wherein retrieving the universal lock carrier is in response to a request for one or more twist-locks having the classification of the twist-lock.

34. The method of claim 31, wherein depositing the twist-lock at the output station may comprises delivering the twist-lock to a container pinning system for use in pinning operations.

35. (canceled)

36. (canceled)

37. (canceled)

38. The method of claim 32, wherein the method comprises updating, deleting, and/or archiving, in/from an inventory database, the data representing the association between the universal lock carrier and the classification of the twist-lock and/or the data representing the association between the storage location and the universal lock carrier.
